(19) United States
(12) Patent Application Publication
(10) Pub. No.: US 2020/0064133 A1
(43) Pub. Date: Feb. 27, 2020

(54) INFORMATION PROCESSING DEVICE, AERIAL PHOTOGRAPHY ROUTE GENERATION METHOD, AERIAL PHOTOGRAPHY ROUTE GENERATION SYSTEM, PROGRAM, AND STORAGE MEDIUM

(71) Applicant: SZ DJI TECHNOLOGY CO., LTD., Shenzhen (CN)

(72) Inventors: Bin CHEN, Shenzhen (CN); Zongyao QU, Shenzhen (CN); Lei GU, Shenzhen (CN)

(21) Appl. No.: 16/665,640

(22) Filed: Oct. 28, 2019

Related U.S. Application Data
(63) Continuation of application No. PCT/JP2017/016792, filed on Apr. 27, 2017.

(51) Int. Cl. G01C 11/02; B64C 39/02; G01C 21/34; G01C 21/16

(52) U.S. Cl. CPC G01C 11/02; B64C 39/024; G01C 21/3407; G01C 2011/36; B64C 2201/123; B64C 2201/127; G01C 21/16

(57) ABSTRACT

An information processing device includes a memory storing a program and a processor configured to execute the program to obtain information about an aerial photography range for a first aerial image and generate an aerial photography route for aerially photographing the first aerial image based on evaluation information of one or more second aerial images aerially photographed in the aerial photography range.

### CROSS-REFERENCE TO RELATED APPLICATION

This application is a continuation of International Application No. PCT/JP2017/016792, filed Apr. 27, 2017, the entire content of which is incorporated herein by reference.

### TECHNICAL FIELD

The disclosure relates to an information processing device for generating an aerial photography route for aerial photography carried out by a flying object, an aerial photography route generation method, an aerial photography route generation system, a program, and a storage medium.

### BACKGROUND ART

There is known a platform (an unmanned aerial vehicle) that carries out photography while travelling along a pre-set fixed route. The platform receives a photography instruction from a ground base and photographs a photography target. When photographing the photography target, while flying along the fixed rote, the platform adjusts the posture of a photographing apparatus thereof according to a positional relationship between the platform and the photography target so as to photograph the photography target.

Patent Document 1: JP-A-2010-61216

### SUMMARY

Although the unmanned aerial vehicle described in Patent Document 1 takes photographs while travelling along a fixed route, the preference of a user of the unmanned aerial vehicle and an objective evaluation are not considered, such that it is not always possible to photograph an attractive subject. That is, the aerial photography route for the aerial photography of an image may not be an aerial photography route where the unmanned aerial vehicle can photograph a subject when considering a subjective or objective evaluation.

In order to photograph an attractive subject, the user manually carries out test photography and searches for a desired aerial photography route. Specifically, the user operates a remote controller (a proportional control system), and the remote controller causes the unmanned aerial vehicle to fly in a desired direction and sends a photography instruction to the unmanned aerial vehicle to cause the unmanned aerial vehicle to photograph an image. The user confirms the image photographed by the unmanned aerial vehicle. In order to confirm a number of factors, such as aerial photography altitude, an aerial photography route, and the setting for a camera at the time of aerial photography, the test photography is repeated multiple times. The remote controller selects a desired aerial photography route from multiple aerial photography routes where the unmanned aerial vehicle flies during test photography, and records the route as an aerial photography route for future aerial photography by user operation.

In this way, when the user manually carries out test photography to search for a desired aerial photography route, test photography needs to be repeated multiple times, and user convenience is reduced. Further, if the user freely tests various aerial photography routes, it is difficult for the user to grasp the situation regarding a site where the unmanned aerial vehicle flies, and information about the site tends to be insufficient. For this reason, there is a possibility that the unmanned aerial vehicle collides with an object and crashes, such that safety of the unmanned aerial vehicle during flight is reduced.

One aspect is an information processing device for generating a first aerial photography route for the aerial photography of a first aerial image by a first flying object. The information processing device includes an acquisition unit for acquiring information about an aerial photography range for the aerial photography of the first aerial image, and a generation unit for generating, based on evaluation information about one or more second aerial images which are aerially photographed in the aerial photography range, the first aerial photography route.

The second aerial image may be an aerial video. The acquisition unit may acquire, based on the evaluation information about one or more of the second aerial images which are aerially photographed in the aerial photography range, at least one piece of information about a second aerial photography route where the second aerial image is photographed. The generation unit may generate, based on one or more of the second aerial photography routes, the first aerial photography route.

The acquisition unit may acquire selection information for selecting one of the multiple second aerial photography routes. The generation unit may set at least a part of the selected second aerial photography route to be the first aerial photography route.

The acquisition unit may acquire a plurality of pieces of information about the second aerial photography route. The generation unit may combine at least some of the multiple second aerial photography routes so as to generate the first aerial photography route.

The multiple second aerial photography routes may include a third aerial photography route and a fourth aerial photography route. The generation unit may acquire a crossing position where the third aerial photography route and the fourth aerial photography route cross each other, and combine a partial aerial photography route, between one end portion of the third aerial photography route and the crossing position, in the third aerial photography route, and a partial aerial photography route, between one end portion of the fourth aerial photography route and the crossing position, in the fourth aerial photography route so as to generate the first aerial photography route.

The multiple second aerial photography routes may include the third aerial photography route and the fourth aerial photography route. The acquisition unit may acquire selection information for selecting an arbitrary part in each of the third aerial photography route and the fourth aerial photography route. The generation unit may combine the selected first part of the third aerial photography route and the selected second part of the fourth aerial photography route so as to generate the first aerial photography route.

Each of the multiple second aerial photography routes may be divided into a plurality of parts. The acquisition unit may acquire, based on partial evaluation information about the second aerial image which is aerially photographed in each of the plurality of parts of each of the multiple second aerial photography routes, a plurality of parts of the second aerial photography route. The generation unit may combine a plurality of portions of the acquired second aerial photography routes so as to generate the first aerial photography route.

The information processing device may further include a display unit for displaying one or more pieces of information about the second aerial photography route.

The second aerial image may be a still aerial image or an aerial video. The acquisition unit may acquire, based on evaluation information about one or more of the second aerial images which are aerially photographed in the aerial photography range, one or more pieces of information about the second aerial photography position or a second aerial photography route where the second aerial image is photographed. The generation unit may generate, based on one or more of the second aerial photography positions or the second aerial photography routes, one or more first aerial photography positions for the aerial photography of the first aerial image. The generation unit may generate a first aerial photography route passing through one or more of the first aerial photography positions.

The generation unit may set the second aerial photography position to be the first aerial photography position.

The acquisition unit may acquire multiple second aerial photography routes. The generation unit may set a crossing position where the multiple second aerial photography routes cross each other to be the first aerial photography position.

The acquisition unit may acquire a plurality of second aerial photography positions and may acquire selection information for selecting one or more second aerial photography positions from the plurality of second aerial photography positions. The generation unit may set the selected second aerial photography position to be the first aerial photography position.

The generation unit may generate a first aerial photography position for each aerial photography section obtained by dividing the aerial photography range.

The acquisition unit may acquire, based on evaluation information about one or more of the second aerial images which are aerially photographed in the aerial photography sections, a plurality of second aerial photography positions in the aerial photography sections, and may acquire, from the plurality of second aerial photography positions, selection information for selecting one or more aerial photography positions. The generation unit may set the selected second aerial photography position to be the first aerial photography position in the aerial photography section.

The generation unit may set a predetermined number of the second aerial photography positions where a predetermined number of the second aerial images are aerially photographed and which are from among those with a high evaluation in the evaluation information about one or more of the second aerial images which are aerially photographed in the aerial photography sections to be the first aerial photography position in the aerial photography section.

The generation unit may generate multiple candidate routes which are candidates for the first aerial photography route passing through the first aerial photography positions, and may determine, based on the respective distance between both end portions of each of the multiple candidate routes, the first aerial photography route from the candidate routes.

The generation unit may generate multiple candidate routes which are candidates for the first aerial photography route passing through the first aerial photography positions, and may determine, based on the respective average curvature of each of the multiple candidate routes, the first aerial photography route from the candidate routes.

The generation unit may generate multiple candidate routes which are candidates for the first aerial photography route passing through the first aerial photography positions, and may determine, based on information about the aerial photography environment of each of the multiple candidate routes and from among the candidate routes, the first aerial photography route.

The information processing device may further include a display unit for displaying one or more pieces of information about the second aerial photography position or the second aerial photography route.

The generation unit may generate, based on evaluation information about one or more of the second aerial images which are aerially photographed in the aerial photography range, first photography information with which the first photographing device of the first flying object photographs the first aerial image.

The evaluation information about the second aerial image may be based on evaluation information from a user who has confirmed the second aerial image.

The evaluation information about the second aerial image may be based on at least one of: the difference between second flight information about the second flying object which aerially photographs the second aerial images when the second aerial images are aerially photographed and first flight information about the first flying object which is scheduled to aerially photograph the first aerial image when the first aerial image is aerially photographed; the evaluation information from the user who has confirmed the second aerial image; or acquisition information based on the number of times the second aerial photography positions or the second aerial photography routes where the second aerial images are aerially photographed are used for generating the first aerial photography route.

In one aspect, an aerial photography route generation method generates a first aerial photography route for the aerial photography of a first aerial image by a first flying object, and the aerial photography route generation method includes a step of acquiring information about an aerial photography range for the aerial photography of the first aerial image, and a step of generating, based on evaluation information about one or more second aerial images which are aerially photographed in the aerial photography range, the first aerial photography route.

The second aerial image may be an aerial video. The aerial photography route generation method may further include a step of acquiring, based on the evaluation information about one or more of the second aerial images which are aerially photographed in the aerial photography range, one or more pieces of information about a second aerial photography route where the second aerial image is photographed. The step of generating the first aerial photography route may include a step of generating, based on one or more of the second aerial photography routes, the first aerial photography route.

The aerial photography route generation method may include a step of acquiring selection information for selecting one of the multiple second aerial photography routes. The step of generating the first aerial photography route may include a step of setting at least a part of the selected second aerial photography route to be the first aerial photography route.

The step of acquiring the information about the second aerial photography route may include a step of acquiring a plurality of pieces of information about the second aerial photography route. The step of generating the first aerial photography route may include a step of combining at least some of the multiple second aerial photography routes so as to generate the first aerial photography route.

The multiple second aerial photography routes may include a third aerial photography route and a fourth aerial photography route. The step of generating the first aerial photography route may include a step of acquiring a crossing position where the third aerial photography route and the fourth aerial photography route cross each other, and a step of combining an aerial photography route which is a part, between one end portion of the third aerial photography route and the crossing position, of the third aerial photography route, and an aerial photography route which is a part, between one end portion of the fourth aerial photography route and the crossing position, of the fourth aerial photography route so as to generate the first aerial photography route.

The multiple second aerial photography routes may include a third aerial photography route and a fourth aerial photography route. The aerial photography route generation method may further include a step of acquiring selection information for selecting an arbitrary part in each of the third aerial photography route and the fourth aerial photography route. The step of generating the first aerial photography route may include a step of combining a first part which is selected from the third aerial photography route and a second part which is selected from the fourth aerial photography route so as to generate the first aerial photography route.

Each of the multiple second aerial photography routes may be divided into a plurality of parts. The step of acquiring the information about the second aerial photography route may include a step of acquiring, based on partial evaluation information about the second aerial image which is aerially photographed in each of the plurality of parts of each of the multiple second aerial photography routes, a plurality of parts of the second aerial photography route. The step of generating the first aerial photography route may include a step of combining a plurality of parts of the acquired second aerial photography routes so as to generate the first aerial photography route.

The aerial photography route generation method may further include a step of displaying one or more pieces of information about the second aerial photography route.

The second aerial image may be a still aerial image or an aerial video. The aerial photography route generation method may further include a step of acquiring, based on evaluation information about one or more of the second aerial images which are aerially photographed in the aerial photography range, one or more pieces of information about a second aerial photography position or a second aerial photography route where the second aerial image is photographed; and a step of generating, based on one or more of the second aerial photography positions or the second aerial photography routes, one or more first aerial photography positions for the aerial photography of the first aerial image. The step of generating the first aerial photography route may include a step of generating a first aerial photography route passing through one or more of the first aerial photography positions.

The step of generating the first aerial photography position may include a step of setting the second aerial photography position to be the first aerial photography position.

The step of acquiring the information about the second aerial photography position or the second aerial photography route may include a step of acquiring multiple second aerial photography routes. The step of generating the first aerial photography position may include a step of setting the crossing position where the multiple second aerial photography routes cross each other to be the first aerial photography position.

The step of acquiring the information about the second aerial photography position or the second aerial photography route may include a step of acquiring a plurality of second aerial photography positions. The aerial photography route generation method may acquire selection information for selecting one or more second aerial photography positions from the plurality of second aerial photography positions. The step of generating the first aerial photography position may include a step of setting the selected second aerial photography position to be the first aerial photography position.

The step of generating the first aerial photography position may include a step of generating a first aerial photography position for each aerial photography section obtained by dividing the aerial photography range.

The step of acquiring the information about the second aerial photography position or the second aerial photography route may include a step of acquiring, based on the evaluation information about one or more of the second aerial images which are aerially photographed in the aerial photography sections, a plurality of second aerial photography positions in the aerial photography sections. The aerial photography route generation method may further include a step of acquiring selection information for selecting one or more aerial photography positions from the plurality of second aerial photography positions in the aerial photography sections. The step of generating the first aerial photography position may include a step of setting the selected second aerial photography position to be the first aerial photography position in the aerial photography section.

The step of generating the first aerial photography position may include a step of setting a predetermined number of the second aerial photography positions where a predetermined number of second aerial images are aerially photographed and which are from among those with a high evaluation in the evaluation information about one or more of the second aerial images which are aerially photographed in the aerial photography sections to be the first aerial photography position in the aerial photography sections.

The step of generating the first aerial photography route may include a step of generating multiple candidate routes which are candidates for the first aerial photography route passing through the first aerial photography positions, and a step of determining, based on the respective distance between both end portions of each of the multiple candidate routes, the first aerial photography route from the candidate routes.

The step of generating the first aerial photography route may include a step of generating multiple candidate routes which are candidates for the first aerial photography route passing through the first aerial photography positions, and a step of determining, based on the respective average curvature of each of the multiple candidate routes, the first aerial photography route from the candidate routes.

The step of generating the first aerial photography route may include a step of generating multiple candidate routes which are candidates for the first aerial photography route passing through the first aerial photography positions, and a step of determining, based on information about the aerial photography environment of each of the multiple candidate routes and from among the candidate routes, the first aerial photography route.

The aerial photography route generation method may further include a step of displaying one or more pieces of information about the second aerial photography position or the second aerial photography route.

The aerial photography route generation method may further include a step of generating, based on the evaluation information about one or more of the second aerial images which are aerially photographed in the aerial photography range, first photography information with which the first photographing device of the first flying object photographs the first aerial image.

The evaluation information about the second aerial image may be based on evaluation information from a user who has confirmed the second aerial image.

The evaluation information about the second aerial image may be based on at least one of: (i) the difference between second flight information about the second flying object which aerially photographs the second aerial images when the second aerial images are aerially photographed and first flight information about the first flying object which is scheduled to aerially photograph the first aerial image when the first aerial image is aerially photographed; (ii) the evaluation information from the user who has confirmed the second aerial image; or (iii) acquisition information based on the number of times the second aerial photography positions or the second aerial photography routes where the second aerial images are aerially photographed are used for generating the first aerial photography route.

In one aspect, an aerial photography route generation system includes an information processing device for generating a first aerial photography route for the aerial photography of a first aerial image by a first flying object, and a recording device for recording a second aerial image and additional information about the second aerial image, and the information processing device acquires information about an aerial photography range for the aerial photography of the first aerial image, and generates, based on evaluation information and based on additional information about one or more of the second aerial images which are aerially photographed in the aerial photography range, the first aerial photography route.

In one aspect, a program is configured to carry out the following steps in an information processing device for generating a first aerial photography route for the aerial photography of a first aerial image by a first flying object: a step of acquiring information about an aerial photography range for the aerial photography of the first aerial image, and a step of generating, based on evaluation information about one or more second aerial images which are aerially photographed in the aerial photography range, the first aerial photography route.

In one aspect, a storage medium is a computer-readable storage medium for recording a program, and the program is configured to carry out the following steps in an information processing device for generating a first aerial photography route for the aerial photography of a first aerial image by a first flying object: a step of acquiring information about an aerial photography range for the aerial photography of the first aerial image, and a step of generating, based on evaluation information about one or more second aerial images which are aerially photographed, the first aerial photography route.

Incidentally, the above summary of the disclosures do not enumerate all features of the disclosure. In addition, sub-combinations of groups of features may also be embodiments of the disclosures.

### BRIEF DESCRIPTION OF THE DRAWINGS

FIG. 1 is a pattern diagram illustrating an example of the configuration of an aerial photography route generation system according to a first embodiment.

FIG. 2 is a block diagram illustrating an example of the hardware configuration of an unmanned aerial vehicle.

FIG. 3 is a block diagram illustrating an example of the hardware configuration of a portable terminal according to the first embodiment.

FIG. 4 is a block diagram illustrating an example of the functional configuration of a terminal control unit according to the first embodiment.

FIG. 5 is a block diagram illustrating an example of the hardware configuration of an image server according to the first embodiment.

FIG. 6 is a block diagram illustrating an example of the functional configuration of a server control unit according to the first embodiment.

FIG. 7A is a diagram illustrating information stored in an image DB.

FIG. 7B is a diagram illustrating the information stored in the image DB (continued from FIG. 7A).

FIG. 8 is a diagram for describing an input example of an aerial photography range.

FIG. 9 is a sequence diagram illustrating an example of an operation when the information is registered in the image DB by the aerial photography route generation system according to the first embodiment.

FIG. 10 is a sequence diagram illustrating an example of an operation when a scheduled aerial photography route is generated by the aerial photography route generation system according to the first embodiment.

FIG. 11 is a diagram illustrating an example of selecting the scheduled aerial photography route from multiple past aerial photography routes.

FIG. 12 is a diagram illustrating a first example of combining multiple aerial photography routes.

FIG. 13 is a diagram illustrating a second example of combining multiple aerial photography routes.

FIG. 14 is a diagram illustrating a third example of combining multiple aerial photography routes.

FIG. 15A is a diagram illustrating an example of an image DB having a user evaluation for some of the aerial photography routes.

FIG. 15B is a diagram illustrating a fourth example of combining multiple aerial photography routes.

FIG. 16 is a pattern diagram illustrating an example of the configuration an aerial photography route generation system according to a second embodiment.

FIG. 17 is a block diagram illustrating an example of the hardware configuration of a portable terminal according to the second embodiment.

FIG. 18 is a block diagram illustrating an example of the functional configuration of a terminal control unit according to the second embodiment.

FIG. 19 is a block diagram illustrating an example of the hardware configuration of an image server according to the second embodiment.

FIG. 20 is a block diagram illustrating an example of the functional configuration of a server control unit according to the second embodiment.

FIG. 21 is a sequence diagram illustrating an example of the operation of the aerial photography route generation system according to the second embodiment.

FIG. 22 is a diagram illustrating a first example of the generation of a scheduled aerial photography position.

FIG. 23 is a diagram illustrating a second example of the generation of a scheduled aerial photography position.

FIG. 24 is a diagram illustrating a third example of the generation a scheduled aerial photography position.

FIG. 25A is a pattern diagram illustrating an example of an aerial photography section.

FIG. 25B is a pattern diagram illustrating another example of the aerial photography section.

FIG. 26 is a pattern diagram illustrating an example of the generation of the scheduled aerial photography position and the scheduled aerial photography route based on the aerial photography section.

FIG. 27A is a pattern diagram illustrating an example of an aerial photography route in a short distance mode.

FIG. 27B is a pattern diagram illustrating an example of the aerial photography route in a smooth mode.

FIG. 27C is a pattern diagram illustrating an example of the aerial photography route in an energy-saving mode.

FIG. 28 is a sequence diagram illustrating a first example of the operation of an aerial photography route generation system according to another embodiment.

FIG. 29 is a sequence diagram illustrating a second example of the operation of the aerial photography route generation system according to the other embodiment.

### DESCRIPTION OF THE EMBODIMENTS

Hereinafter, the present disclosure will be described through embodiments. However, the following embodiments are not intended to limit the invention according to the claims. None of the combinations of features described in the embodiments are necessarily indispensable for the solution means of the disclosure.

The claims, description, drawings, and abstract include matters subject to copyright protection. The copyright holder does not object to the copying, by any person, of these documents, as long as the documents are as appears on the file or record of the Patent Office. However, in all other cases, all copyrights are reserved.

In the following embodiment, examples of a flying object may include an unmanned aerial vehicle (UAV). The flying object includes aircraft moving through air. In the drawings of the description, the unmanned aerial vehicle is referred to as a “UAV”. In addition, examples of an information processing device may include a portable terminal. In addition to the portable terminal, the information processing device may include, for example, an unmanned aerial vehicle, a transmitter, a personal computer (PC), or other information processing devices. An aerial photography route generation method defines operations in the information processing device. A storage medium records a program (for example, a program for causing the information processing device to execute various processes).

### First Embodiment

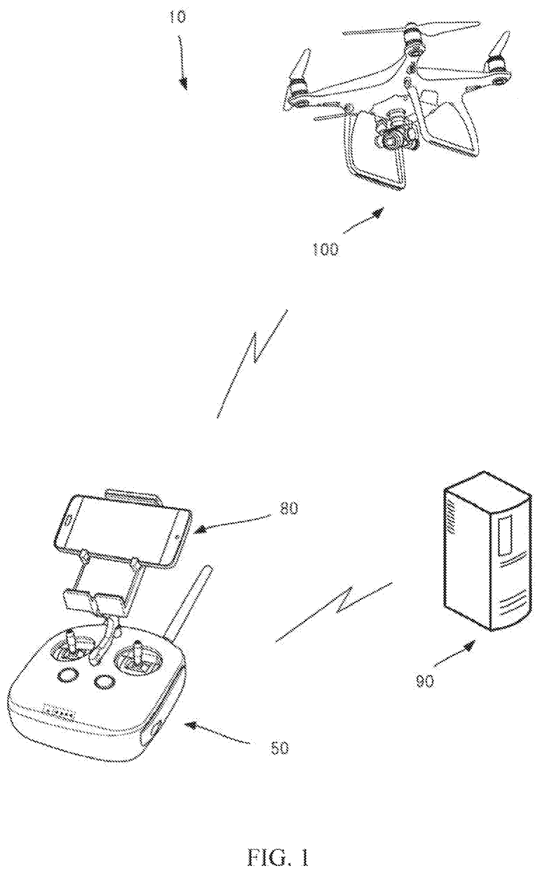

FIG. 1 is a pattern diagram illustrating an example of the configuration of an aerial photography route generation system 10 according to the first embodiment. The aerial photography route generation system 10 includes one or more unmanned aerial vehicles 100, a transmitter 50, a portable terminal 80, and an image server 90. The unmanned aerial vehicle 100, the transmitter 50, the portable terminal 80, and the image server 90 can communicate with each other by means of wired communication or wireless communication (for example, a wireless local area network (LAN)).

An unmanned aerial vehicle 100 can fly based on remote control by the transmitter 50 or fly according to a pre-set flight route. The transmitter 50 instructs the control of the flight of the unmanned aerial vehicle 100 by means of remote control. That is, the transmitter 50 operates as a remote controller. The portable terminal 80 may be owned by a user scheduled to carry out aerial photography by using the unmanned aerial vehicle 100 together with the transmitter 50. The portable terminal 80 cooperates with the image server 90 to generate an aerial photography route for the unmanned aerial vehicle 100. The image server 90 retains an aerial image aerially photographed by one or more unmanned aerial vehicles 100 and additional information thereabout. The image server 90 can provide the retained aerial image and the additional information thereabout in response to a request from the portable terminal 80.

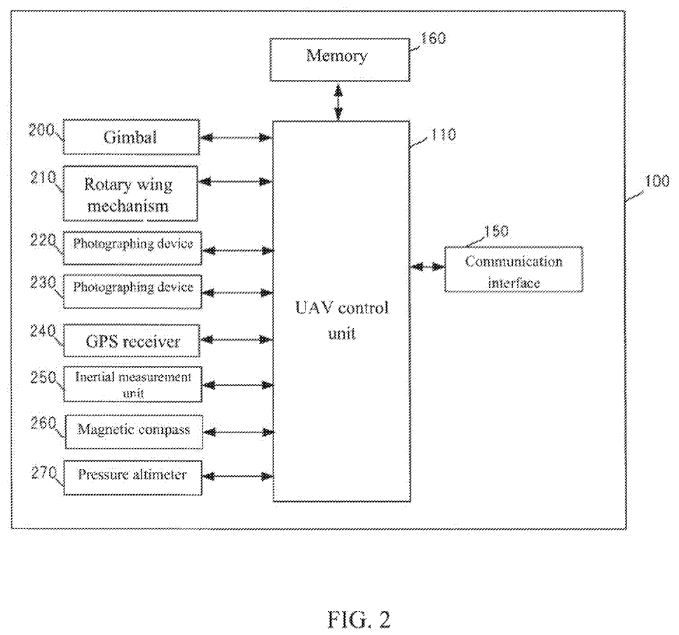

FIG. 2 is a block diagram illustrating an example of the hardware configuration of the unmanned aerial vehicle 100. The unmanned aerial vehicle 100 includes a UAV control unit 110, a communication interface 150, a memory 160, a gimbal 200, a rotary wing mechanism 210, a photographing device 220, a photographing device 230, a GPS receiver 240, an inertial measurement unit (IMU)250, a magnetic compass 260, and a pressure altimeter 270.

The UAV control unit 110 is configured using, for example, a central processing unit (CPU), a micro processing unit (MPU) or a digital signal processor (DSP). The UAV control unit 110 carries out signal processing for integrating and controlling operations of each unit of the unmanned aerial vehicle 100, the input/output processing of data with other units, data arithmetic processing and data storage processing.

The UAV control unit 110 controls the flight of the unmanned aerial vehicle 100 according to a program stored in the memory 160. The UAV control unit 110 controls the flight of the unmanned aerial vehicle 100 according to a command received from the remote transmitter 50 via the communication interface 150. The memory 160 may be removable from the unmanned aerial vehicle 100.

The UAV control unit 110 acquires position information indicating the position of the unmanned aerial vehicle 100. The UAV control unit 110 may acquire, from the GPS receiver 240, position information indicating the latitude, longitude and altitude where the unmanned aerial vehicle 100 is located. The UAV control unit 110 may acquire, from the GPS receiver 240, latitude and longitude information indicating the latitude and longitude where the unmanned aerial vehicle 100 is located, and may acquire, from the pressure altimeter 270, altitude information indicating the altitude where the unmanned aerial vehicle 100 is located, which information acts as the position information.

The UAV control unit 110 acquires, from the magnetic compass 260, orientation information indicating the orientation of the unmanned aerial vehicle 100. For example, an orientation corresponding to the orientation of the nose of the unmanned aerial vehicle 100 is indicated in the orientation information.

The UAV control unit 110 acquires photography information indicating photography ranges of the photographing device 220 and the photographing device 230. The UAV control unit 110 acquires, from the photographing device 220 and the photographing device 230, angle of view information indicating the angles of view of the photographing device 220 and the photographing device 230, which information acts as parameters for specifying the photography ranges. The UAV control unit 110 acquires information indicating photography directions of the photographing device 220 and the photographing device 230, which information acts parameters for specifying the photography ranges. The UAV control unit 110 acquires, from the gimbal 200, posture information indicating the state of posture of the photographing device 220, which information acts as information indicating the photography direction of the photographing device 220, for example. The UAV control unit 110 acquires information indicating the orientation of the unmanned aerial vehicle 100. The information indicating the state of posture of the photographing device 220 indicates the angle of rotation from a reference rotation angle of a yaw axis, a pitch axis, and a roll axis of the gimbal 200. The UAV control unit 110 acquires the position information indicating the position where the unmanned aerial vehicle 100 is located, which information acts as a parameter for specifying the photography range. The UAV control unit 110 may acquire photography information by defining a photography range indicating a geographical range captured by the photographing device 220 and by generating, based on the angles of view and the photography directions of the photographing device 220 and the photographing device 230, and the location where the unmanned aerial vehicle 100 is present, photography information indicating the photography range.

The UAV control unit 110 controls the gimbal 200, the rotary wing mechanism 210, the photographing device 220, and the photographing device 230. The UAV control unit 110 controls the photography range of the photographing device 220 by changing the photography direction and angle of view of the photographing device 220. The UAV control unit 110 controls the photography range of the photographing device 220 supported by the gimbal 200 by controlling a rotation mechanism of the gimbal 200.

The photography range refers to a geographical range captured by the photographing device 220 or the photographing device 230. The photography range is defined by a latitude, a longitude, and an altitude. The photography range may be a range, defined by a latitude, a longitude, and an altitude, in three-dimensional spatial data. The photography range is specified based on the angle of view and photography direction of the photographing device 220 or the photographing device 230 and the position where the unmanned aerial vehicle 100 is located. The photography direction of the photographing device 220 or the photographing device 230 is defined by an orientation in which the front, where a photography lens of the photographing device 220 or the photographing device 230 is provided, is pointing and a depression angle. The photography direction of the photographing device 220 is a direction specified based on the orientation of the nose of the unmanned aerial vehicle 100 and the state of posture of the photographing device 220 with respect to the gimbal 200. The photography direction of the photographing device 230 is a direction specified based on the orientation of the nose of the unmanned aerial vehicle 100 and the position where the photographing device 230 is located.

For an image (an aerial image) photographed by the photographing device 220 or the photographing device 230, the UAV control unit 110 adds information about the aerial image, this acting as additional information (an example of metadata). The additional information includes information about the flight of the unmanned aerial vehicle 100 during aerial photography (flight information) and information about photography by the photographing device 220 or the photographing device 230 during aerial photography (photography information). The flight information may include at least one from among aerial photography position information, aerial photography route information, aerial photography time point information, aerial photography time period information, and aerial photography weather information. The photography information may include at least one from among aerial photography angle of view information, aerial photography direction information, aerial photography posture information, and photography range information.

The aerial photography position information indicates the position where the aerial image is aerially photographed (an aerial photographing position). The aerial photography position information may be based on the position information acquired by the GPS receiver 240. The aerial photography position information is information about the position where a still aerial image is aerially photographed. The aerial photography position information indicates a route on which the aerial image is aerially photographed (an aerial photography route). The aerial photography route information is route information about when a video is acquired as an aerial image, and may be configured by a set of aerial photography positions where the aerial photography positions are continuously connected. The aerial photography route information may be information about a set of positions where an aerial video is photographed. The aerial photography time point information indicates a time point when the aerial image is aerially photographed (an aerial photography time point). The aerial photography time point information may be based on time point information of a timer referred to by the UAV control unit 110. The aerial photography time period information indicates a time period when the aerial image is aerially photographed (an aerial photography time period). The aerial photography time point information may be based on date and time information from the timer referred to by the UAV control unit 110. The aerial photography weather information indicates the weather when the aerial image is aerially photographed. For example, the aerial photography weather information may be based on detection information detected by the unmanned aerial vehicle 100 by using a thermometer and a hygrometer, which are not shown, or may be based on weather information acquired from an external server via the communication interface 150.

The aerial photography angle of view information indicates the angle of view information of the photographing device 220 or the photographing device 230 when the aerial image is aerially photographed. The aerial photography direction information indicates the photography direction of the photographing device 220 or the photographing device 230 when the aerial image is aerially photographed (an aerial photography direction). The aerial photography posture information indicates the posture information of the photographing device 220 or the photographing device 230 when the aerial image is aerially photographed. The photography range information indicates the photography range of the photographing device 220 or the photographing device 230 when the aerial image is aerially photographed.

In addition, the photography information may include the orientation of the unmanned aerial vehicle 100 during aerial photography. In addition, the additional information may include image type information, which indicates whether the aerial image is a video (an aerial video) or a still image (a still aerial image).

The communication interface 150 communicates with the transmitter 50, the portable terminal 80, and the image server 90. The communication interface 150 receives information about an aerial photography route from a device which generates the aerial photography route. The device where the aerial photography route is generated may be the transmitter 50, the portable terminal 80, or other devices. The communication interface 150 transmits, to the image server 90, at least a part of the aerial image photographed by the photographing device 220 or the photographing device 230 and the additional information added to the aerial image. The transmitted aerial image and the additional information thereabout are data and information to be registered in an image DB 991 of the image server 90.

The communication interface 150 receives various instructions and information from the remote transmitter 50 regarding the UAV control unit 110.

The memory 160 stores programs or the like necessary for the UAV control unit 110 to control the gimbal 200, the rotary wing mechanism 210, the photographing device 220, the photographing device 230, the GPS receiver 240, the inertial measurement unit 250, the magnetic compass 260, and the pressure altimeter 270. The memory 160 may be a computer-readable storage medium, and may include at least one of a static random access memory (SRAM), a dynamic random access memory (DRAM), an erasable programmable read-only memory (EPROM), an electrically erasable programmable read-only memory (EEPROM), or a flash memory such as a USB memory.

The memory 160 can store the information, acquired via the communication interface 150 or the like, about the aerial photography route. The information about the aerial photography route may be read from the memory 160 during aerial photography and the unmanned aerial vehicle 100 may fly along the aerial photography route.

The gimbal 200 may support the photographing device 220 such that same can rotate around the yaw axis, the pitch axis, and the roll axis. The gimbal 200 causes the photographing device 220 to rotate around the centre of at least one of the yaw axis, the pitch axis, or the roll axis, and thus, the photography direction of the photographing device 220 may be changed.

The yaw axis, the pitch axis and the roll axis may be defined as follows. For example, the roll axis is defined in a horizontal direction (a direction parallel to the ground). In this case, the pitch axis is defined in a direction parallel to the ground and perpendicular to the roll axis, and the yaw axis (see the z axis) is defined in a direction perpendicular to the ground and perpendicular to the roll axis and the pitch axis.

The photographing device 220 photographs an image of a subject in a desired photography range and generates data about the image. The image data acquired by the photography of the photographing device 220 is stored in a memory of the photographing device 220 or the memory 160.

The photographing device 230 photographs the surroundings of the unmanned aerial vehicle 100 and generates data about the image. The image data from the photographing device 230 is stored in the memory 160.

The GPS receiver 240 receives a plurality of signals indicating time points when a plurality of navigation satellites (i.e., GPS satellites) send signals, and the positions (coordinates) of the GPS satellites. The GPS receiver 240 calculates, based on the received plurality of signals, the position of the GPS receiver 240 (i.e., the position of the unmanned aerial vehicle 100). The GPS receiver 240 outputs the position information of the unmanned aerial vehicle 100 to the UAV control unit 110. Incidentally, the calculation of the position information by the GPS receiver 240 may be carried out by the UAV control unit 110 instead of the GPS receiver 240. In this case, the time points and the positions of the GPS satellites included in the plurality of signals received by the GPS receiver 240 are input into the UAV control unit 110.

The inertial measurement unit 250 detects the posture of the unmanned aerial vehicle 100 and outputs the detection result to the UAV control unit 110. The inertial measurement unit IMU 250 detects accelerations in three axial directions, i.e., the front-rear, left-right, and up-down directions, and angular velocities in three axial directions, i.e., the pitch axis, the roll axis, and the yaw axis, of the unmanned aerial vehicle 100 to be the posture of the unmanned aerial vehicle 100.

The magnetic compass 260 detects the orientation of the nose of the unmanned aerial vehicle 100, and outputs the detection result to the UAV control unit 110.

The pressure altimeter 270 detects the flight altitude of the unmanned aerial vehicle 100 and outputs the detection result to the UAV control unit 110. Incidentally, the flight altitude of the unmanned aerial vehicle 100 may be detected by a sensor other than the pressure altimeter 270.

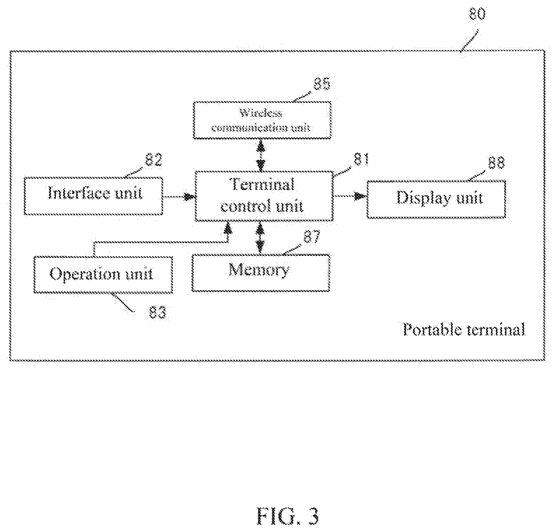

FIG. 3 is a block diagram illustrating an example of the hardware configuration of the portable terminal 80. The portable terminal 80 may include a terminal control unit 81, an interface unit 82, an operation unit 83, a wireless communication unit 85, a memory 87, and a display unit 88. The portable terminal 80 is an example of the information processing device. The operation unit 83 is an example of the acquisition unit.

The terminal control unit 81 is configured to use a CPU, an MPU or a DSP, for example. The terminal control unit 81 carries out signal processing for integrating and controlling operations of each unit of the portable terminal 80, the input/output processing of data with other units, data arithmetic processing and data storage processing.

The terminal control unit 81 may acquire data and information from the unmanned aerial vehicle 100 via the wireless communication unit 85. The terminal control unit 81 may acquire data and information from the transmitter 50 via the interface unit 82. The terminal control unit 81 may acquire input data and information via the operation unit 83. The terminal control unit 81 may acquire data and information retained in the memory 87. The terminal control unit 81 may send the data and information to the display unit 88, and may cause the display unit 88 to display display information based on the data and information.

The terminal control unit 81 may execute an aerial photography route generation application. The aerial photography route generation application may be an application that generates an aerial photography route for the aerial photography of an image by the unmanned aerial vehicle 100. The terminal control unit 81 may generate various pieces of data used in the application.

The interface unit 82 carries out the inputting/outputting of the information and data between the transmitter 50 and the portable terminal 80. The interface unit 82 may carry out inputting/outputting via a USB cable, for example. The interface unit 65 may be an interface other than a USB.

The operation unit 83 receives data and information input by a user of the portable terminal 80. The operation unit 83 may include a button, a key, a touch panel, a microphone, or the like. Herein, the operation unit 83 and the display unit 88 being configured by the touch panel is mainly exemplified. In this case, the operation unit 83 can receive a touch operation, a tap operation, a drag operation, or the like.

The wireless communication unit 85 communicates with the unmanned aerial vehicle 100 and the image server 90 in a wireless manner by means of various wireless communication methods. The wireless communication methods may include, for example, wireless LAN, Bluetooth (a registered trademark), or communication via a public wireless line.

The memory 87 may include, for example, a ROM, in which programs defining the operation of the portable terminal 80 and set value data are stored, and a RAM for temporarily saving various pieces of information and data used in the processing of the terminal control unit 81. The memory 87 may include a memory other than the ROM and the RAM. The memory 87 may be provided in the portable terminal 80. The memory 87 may be provided such that same can be detached from the portable terminal 80. The program may include an application program.

The display unit 88 is configured using, for example, a liquid crystal display (LCD), and displays various pieces of information and data output from the terminal control unit 81. The display unit 88 may display various pieces of data and information about the execution of the aerial photography route generation application.

Incidentally, the portable terminal 80 may be mounted on the transmitter 50 via a holder. The portable terminal 80 and the transmitter 50 may be connected via a wired cable (for example, the USB cable). If the portable terminal 80 is mounted on the transmitter 50, the portable terminal 80 and the transmitter 50 may be provided separately.

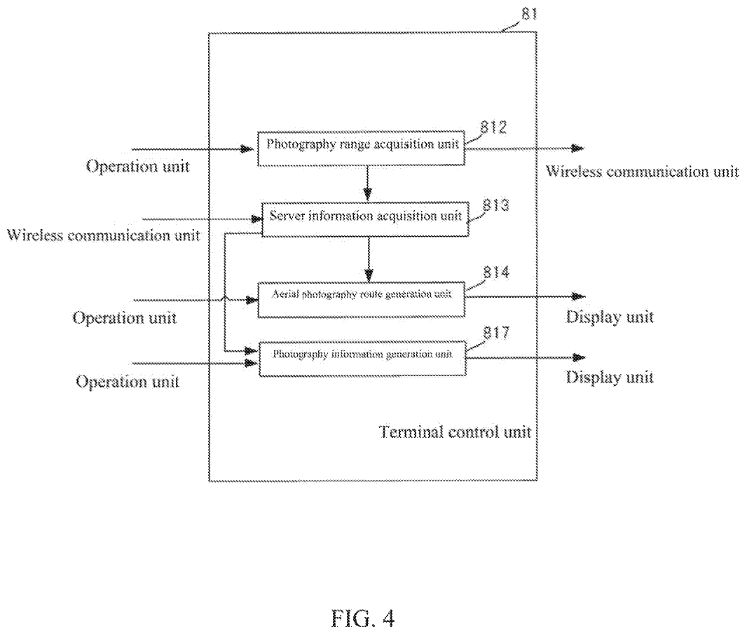

FIG. 4 is a block diagram illustrating an example of the functional configuration of the terminal control unit 81. The terminal control unit 81 includes an aerial photography range acquisition unit 812, a server information acquisition unit 813, an aerial photography route generation unit 814, and a photography information generation unit 817. The aerial photography range acquisition unit 812 is an example of the acquisition unit. The server information acquisition unit 813 is an example of the acquisition unit. The aerial photography route generation unit 814 is an example of the generation unit.

The aerial photography range acquisition unit 812 acquires information about the aerial photography range via the operation unit 83. The aerial photography range may be a geographical aerial photography range which is to be aerially photographed by the unmanned aerial vehicle 100. The information about the aerial photography range may be information about a specific two-dimensional position (for example, latitude and longitude values). In addition, the information about the aerial photography range may be information about a geographical name (for example, “Daiba”) indicating a specific geographical location. The acquired information about the aerial photography range is sent to the image server 90 via the wireless communication unit 85.

The server information acquisition unit 813 acquires the data and information from the image server 90 via the wireless communication unit 85, for example. The data and information acquired from the image server 90 is at least some of the additional information which is based on the information about the aerial photography range and which is transmitted via the portable terminal 80. The server information acquisition unit 813 may acquire information about the aerial photography route (referred to as a past aerial photography route) recorded in the image DB 991. The server information acquisition unit 813 may acquire the photography information (referred to as past photography information) recorded in the image DB 991. As described above, the past photography information may include at least one of the aerial photography angle of view information, the aerial photography direction information, the aerial photography posture information, or the photography range information about when the aerial image is aerially photographed.

The aerial photography route generation unit 814 generates an aerial photography route included in the aerial photography range. The aerial photography route generation unit 814 may generate, based on the acquired one or more past aerial photography positions, an aerial photography route (also referred to as a scheduled aerial photography route) for future aerial photography by the unmanned aerial vehicle 100.

The photography information generation unit 817 generates photography information (also referred to as scheduled photography information) of the photographing device 220 or the photographing device 230 when same flies along the scheduled aerial photography route included in the aerial photography range and carries out aerial photography. The photography information generation unit 817 may generate, based on the past photography information corresponding to the acquired past aerial photography route, the scheduled photography information.

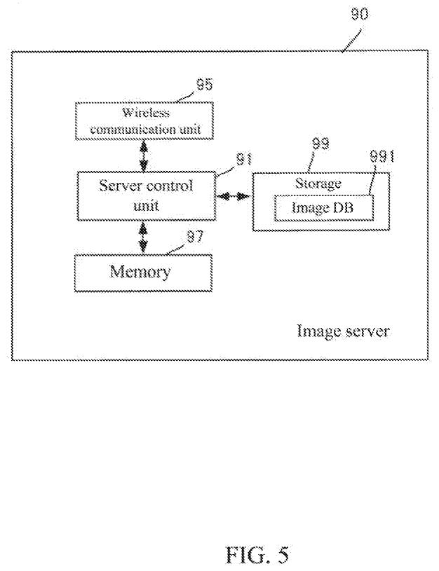

FIG. 5 is a block diagram illustrating an example of the hardware configuration of the image server 90. The image server 90 may include a server control unit 91, a wireless communication unit 95, a memory 97, and a storage 99.

The server control unit 91 is configured to use a CPU, an MPU or a DSP, for example. The server control unit 91 carries out signal processing for integrating and controlling operations of each unit of the image server 90, the input/output processing of data with other units, data arithmetic processing and data storage processing.

The server control unit 91 may acquire data and information from the unmanned aerial vehicle 100 via the wireless communication unit 95. The server control unit 91 may acquire data and information retained in the memory 97 or the storage 99. The server control unit 91 may send the data and information to the portable terminal 80, and may cause the display unit 88 to display display information based on the data and information.

The wireless communication unit 95 communicates with the unmanned aerial vehicle 100 and the portable terminal 80 by means of various wireless communication methods. The wireless communication methods may include, for example, wireless LAN, Bluetooth (a registered trademark), or communication via a public wireless line.

The memory 97 may include, for example, a ROM, in which programs defining the operation of the image server 90 and set value data are stored, and a RAM for temporarily saving various pieces of information and data used in the processing of the server control unit 91. The memory 97 may include a memory other than the ROM and the RAM. The memory 97 may be provided in the image server 90. The memory 97 may be provided such that same can be detached from the image server 90.

The storage 99 accumulates and retains various pieces of data and information. The storage 99 includes an image DB 991. The storage 99 may be an HDD, an SSD, an SD card, a USB memory, or the like. The storage 99 may be provided in the image server 90. The storage 99 may be provided such that same can be detached from the image server 90.

The image DB 991 accumulates and retains the acquired aerial image and additional information thereabout via the wireless communication unit 95. The accumulated aerial image (referred to as a past aerial image) may include an aerial image photographed and transmitted by one or more unmanned aerial vehicles 100. As described above, the additional information may include information about the flight of the unmanned aerial vehicle 100 during aerial photography related to the past aerial image (past flight information) and information about the photographing device 220 or 230 during aerial photography (past photography information). The image DB 991 may send at least a part of the past aerial image and the additional information thereabout to the server control unit 91 in response to a request from the server control unit 91.

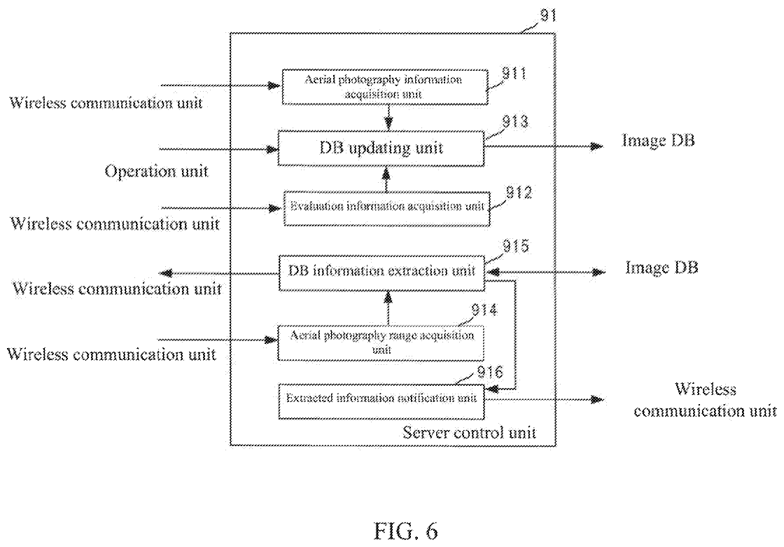

FIG. 6 is a block diagram illustrating an example of the functional configuration of the image server 90. The server control unit 91 includes an aerial photography information acquisition unit 911, an evaluation information acquisition unit 912, a DB updating unit 913, an aerial photography range acquisition unit 914, and a DB information extraction unit 915.

The aerial photography information acquisition unit 911 acquires an aerial image and additional information thereabout from one or more unmanned aerial vehicles 100 via the wireless communication unit 95. The acquired aerial image and the additional information thereabout are data and information which are to be registered in the image DB 991.

The evaluation information acquisition unit 912 acquires, from one or more portable terminals 80 or other communication devices (for example, a PC or a tablet terminal) and via the wireless communication unit 95, evaluation information about the aerial image accumulated in the image DB 991. The evaluation information may include information about an evaluation, by a user, regarding the aerial image.

The DB updating unit 913 registers the aerial image acquired by the aerial photography information acquisition unit 911 and additional information thereabout in the image DB 991. That is, the DB updating unit 913 updates the image DB 991 by newly retaining the aerial image and the additional information in the image DB 991.

The aerial photography range acquisition unit 914 acquires, from the portable terminal 80, information about the aerial photography range via the wireless communication unit 95. The information about the aerial photography range is equivalent to a scheduled photography range which is aerially photographed by the unmanned aerial vehicle 100.

The DB information extraction unit 915 searches the image DB 991 based on the acquired aerial photography range, and extracts data and information from the image DB 991. For example, the DB information extraction unit 915 may extract, by using the aerial photography range as the key, one or more pieces of additional information about an aerial image (aerial video) which is aerially photographed on the aerial photography route included in the aerial photography range. The DB information extraction unit 915 may extract, by using the aerial photography range as a key and from the additional information about the aerial image photographed on the aerial photography route included in the aerial photography range, additional information about an aerial image with a high evaluation. The aerial image with a high evaluation may be, for example, an aerial image, the evaluation value (for example, a user evaluation value) of which indicates that an evaluation is equal to or more than a predetermined value, or may be an aerial image, the evaluation value of which is higher than an average evaluation value of all aerial images photographed on the aerial photography route included in the aerial photography range. The additional information to be extracted may include at least some of the information about the aerial photography route where the aerial image, to which the additional information is added, is aerially photographed.

An extracted information notification unit 916 transmits the data and information extracted from the image DB 991 to the portable terminal 80 via the wireless communication unit 95.

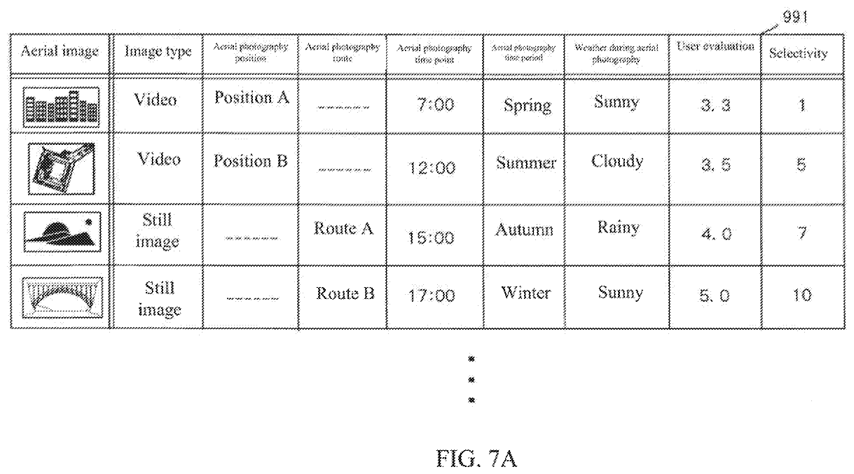

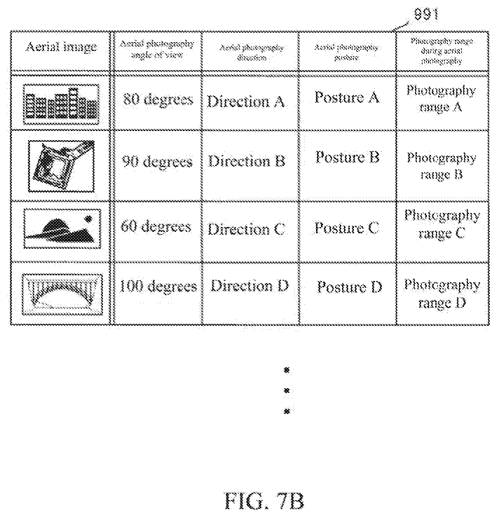

FIGS. 7A and 7B are pattern diagrams illustrating, in table format, the information stored in the image DB 991. The image DB 991 retains an aerial image and additional information thereabout. The aerial image includes at least one of an aerial video or a still aerial image. In the present embodiment, the aerial image may include at least an aerial video and may include a still aerial image. In a second embodiment, which will be-described later, the aerial image includes at least one of an aerial video or a still aerial image.

In FIGS. 7A and 7B, the additional information may include image type information, aerial photography position information, aerial photography route information, aerial photography time point information, aerial photography time period information, and aerial photography weather information. The aerial photography position information may be recorded when the aerial photography type information indicates a still aerial image, and may not be recorded when the aerial photography type information indicates an aerial video. The aerial photography route information may be recorded when the aerial photography type information indicates an aerial video, and may be not recorded when the aerial photography type information indicates a still aerial image. In FIGS. 7A and 7B, the additional information includes user evaluation information and selectivity information. In addition, in FIGS. 7A and 7B, the additional information may include aerial photography angle of view information, aerial photography direction information, aerial photography posture information, and photography range information. FIGS. 7A and 7B are separated for illustrative purposes, but may be stored in one table.

The user evaluation information indicates the evaluation, by a user, regarding the aerial image registered in the image DB 991. For example, the user operates the portable terminal 80, and the portable terminal 80 receives, regenerates and displays the aerial image registered in the image DB 991. The user confirms an aerial image (an aerial video or a still aerial image), and inputs an evaluation regarding the aerial image via the operation unit 83 of the portable terminal 80. The input evaluation information is transmitted to the image server 90 via the wireless communication unit 85 of the portable terminal 80, and is registered in the image DB 991 retained by the image DB 991 of the image server 90. The user evaluation may be carried out via an application on the Web or a social networking service (SNS).

The input evaluation information may be a user evaluation value indicated by any one of points 0 to 5, for example. The user evaluation information may be indicated by a statistical value, such as the average value of user evaluation values from each user. The input evaluation information may be information such as good/bad, like/dislike, ◯/X, or the like. The user evaluation information may be indicated by a statistical value, such as good, preference, a total value of ◯, etc. The input evaluation information may be evaluation A, evaluation B, evaluation C, or the like. The user evaluation information may be statistical information, such as the average value of user evaluation values from each user. Such user evaluation information may be registered by a plurality of users.

The selectivity information indicates the number of times that the aerial photography route or the aerial photography position registered in the image DB 991 is extracted in response to a request from one or more portable terminals 80. That is, the selectivity information indicates to what extent the past aerial photography route or the past aerial photography position recorded in the image DB 991 has been selected. The selectivity may be the number of times that the same past aerial photography route was selected (the number of times of selection), may be the ratio of the selection of one aerial photography route to the number of times all the aerial photography routes (selectivity) were selected, or may be information about the selection of other aerial photography routes. Similarly, the selectivity may be the number of times that the same aerial photography position was selected (the number of times of selection), may be the ratio of the selection of one aerial photography position to the number of times all the aerial photography positions (selectivity) were selected, or may be information about the selection of other aerial photography positions. The selectivity information may be updated by the DB information extraction unit 915 every time the selectivity information is extracted from the image DB 991 so as to generate a scheduled aerial photography position or a scheduled aerial photography route by means of the DB information extraction unit 915. That is, when same is frequently used as the scheduled aerial photography route or the scheduled aerial photography position, the selectivity becomes large.

Incidentally, in the image DB 991, the additional information about the past aerial image may be recorded, and a record of the past aerial image itself may be omitted.

FIG. 8 is a diagram for describing an input example of the aerial photography range.

The portable terminal 80 may be owned by a user scheduled to carry out aerial photography. In the portable terminal 80, the operation unit 83 inputs information about an aerial photography range A1. The operation unit 83 may receive a user input in a desired range where aerial photography is desired to be carried out and which is indicated by map information Ml, the range acting as the aerial photography range A1. In addition, the operation unit 83 may input a place name or the name of a building or other information that can specify a location (also referred to as a place name, etc.) where aerial photography is desired to be carried out. In this case, the aerial photography range acquisition unit 812 may acquire a range indicated by the place name or the like and which acts as the aerial photography range A1, or may acquire a predetermined range around the place name or the like (for example, a range of a radius of 100 m around the position indicated by the place name), which range as the aerial photography range A1.

Next, an example of the operation of the aerial photography route generation system 10 will be described.

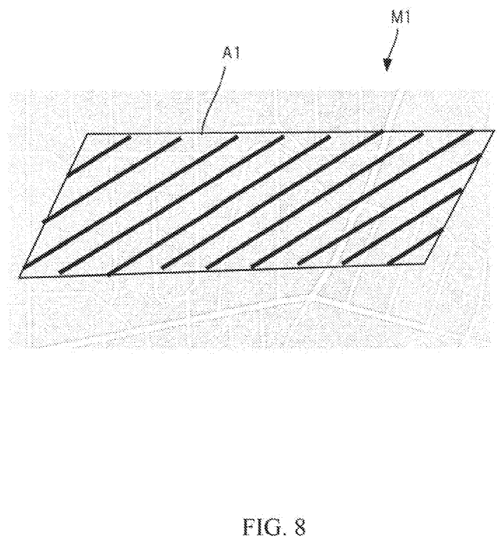

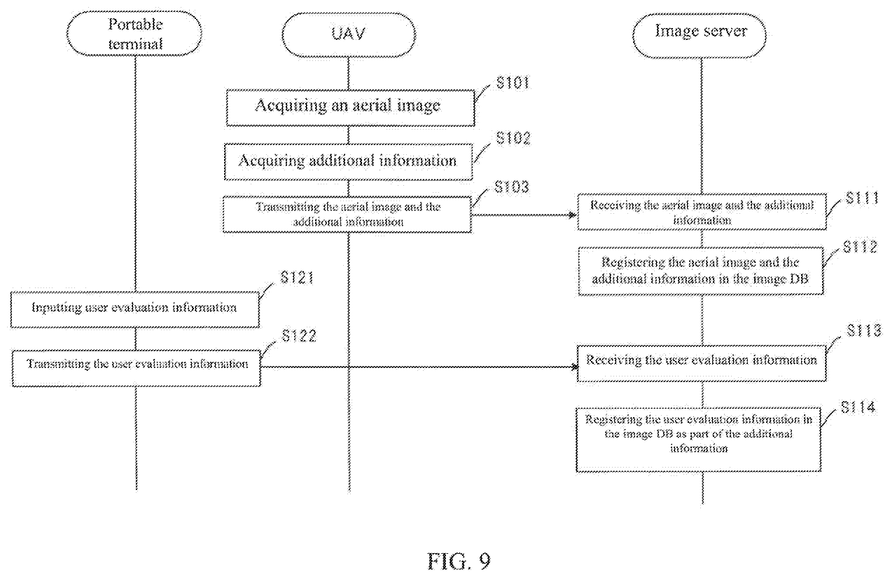

FIG. 9 is a flow chart illustrating an example of the operation when the information is registered in the image DB 991 by the aerial photography route generation system 10.

In the unmanned aerial vehicle 100, the photographing device 220 or the photographing device 230 photographs an image while flying and acquires an aerial image (S101). The UAV control unit 110 acquires additional information (S102). The communication interface 150 transmits the aerial image and the additional information thereabout to the image server 90 (S103). Incidentally, the aerial image and the additional information thereabout may be transmitted to the image server 90 via the transmitter 50 or the portable terminal 80.

In the image server 90, the wireless communication unit 95 receives, from the unmanned aerial vehicle 100, the aerial image and the additional information thereabout (S111). The DB updating unit 913 registers the aerial image and the additional information thereabout in the image DB 991 (S112).

In addition, in the portable terminal 80, the wireless communication unit 85 acquires the desired aerial image from the image server 90. A user of the portable terminal 80 confirms the acquired aerial image via the display unit 88, and determines a user evaluation. The operation unit 83 of the portable terminal 80 inputs user evaluation information from the user (S121). The wireless communication unit 85 transmits the user evaluation information to the image server 90 (S122).

In the image server 90, the wireless communication unit 95 receives the user evaluation information from the portable terminal 80 (S113). The DB updating unit 913 updates, based on the received user evaluation information, the user evaluation information included in the additional information (S114).

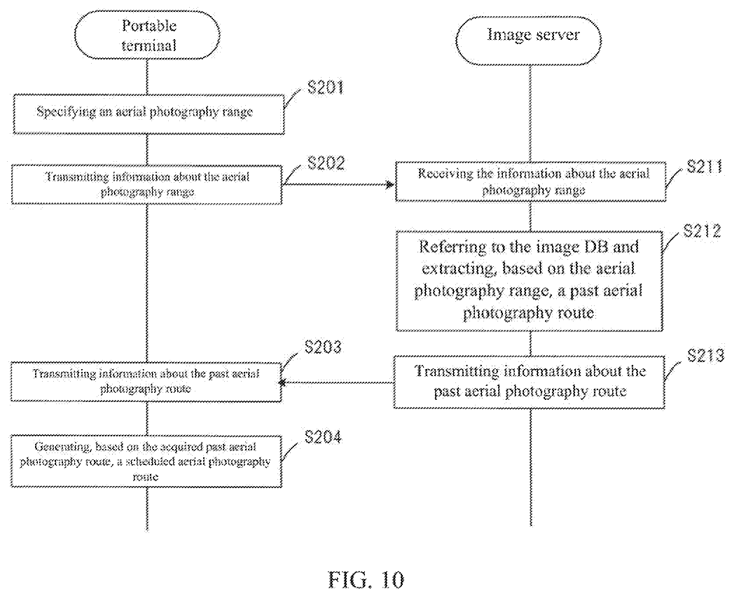

FIG. 10 is a flow chart illustrating an example of the operation when a scheduled aerial photography route is generated by the aerial photography route generation system 10. Herein, it is assumed that there is already one aerial image and additional information thereabout in the image DB 991.

First, in the portable terminal 80, the aerial photography range acquisition unit 812 acquires the information about the aerial photography range A1 (S201). The wireless communication unit 85 transmits the acquired information about the aerial photography range A1 to the image server 90 (S202).

In the image server 90, the aerial photography range acquisition unit 914 receives the information about the aerial photography range A1 (S211). The DB information extraction unit 915 refers to the image DB 991 and extracts, based on the aerial photography range A1, a past aerial photography route (S212). For example, the DB information extraction unit 915 may extract, by using the aerial photography range A1 as a key, one or more past aerial photography routes which are included in the aerial photography range A1 and where an aerial image, the evaluation value of which is equal to or larger than a predetermined value (for example, a user evaluation value is equal to or greater than a value of 3.5, or is equal to or higher than evaluation B) is aerially photographed. The extracted information notification unit 916 transmits, to the portable terminal 80, the information about the past aerial photography route via the wireless communication unit 95 (S213).

In the portable terminal 80, the server information acquisition unit 813 acquires, from the image server 90, information about the past aerial photography route via the wireless communication unit 85 (S203). The aerial photography route generation unit 814 generates, based on the acquired past aerial photography route, a scheduled aerial photography route (S204). Information about the generated scheduled aerial photography route is sent to the unmanned aerial vehicle 100 and set to be an aerial photography route for the unmanned aerial vehicle 100.

Accordingly, when a first unmanned aerial vehicle 100 carries out aerial photography, the aerial image and the additional information thereabout are registered in the image DB 991. Before a second unmanned aerial vehicle 100 starts flight for aerial photography, the portable terminal 80 cooperates with the image server 90 to acquire the past aerial photography route, along which aerial photography was carried out, in a region to be aerially photographed (the aerial photography range A1). The second unmanned aerial vehicle 100 generates a scheduled aerial photography route from the past aerial photography route. When the second unmanned aerial vehicle flies along the scheduled aerial photography route and carries out aerial photography, the aerial image and additional information thereabout are registered in the image DB 991. Therefore, each time the unmanned aerial vehicle 100 carries out aerial photography based on the image DB 991, the aerial image and the additional information thereabout are registered. For example, when an aerial photography route with a high evaluation is selected, it is expected that the user who is planning to take an aerial photograph is also highly satisfied because same is an aerial photography route where an aerial photography image which satisfied other users was aerially photographed. Also, it is expected that the flying frequency also becomes high and the user evaluation becomes higher with regard to the aerial photography route related to the aerial image with a high evaluation. Therefore, the image server 90 can provide information about a recommended aerial photography route recorded in the image DB 991 in an opportunity learning manner.

Therefore, according to the portable terminal 80 and the aerial photography route generation system 10, a scheduled aerial photography route can be generated based on the information recorded in the image DB 991. Therefore, in order to photograph an attractive subject, it is not necessary for the user to manually carry out test photography and search for a desired aerial photography route. Therefore, the portable terminal 80 and the aerial photography route generation system 10 can reduce the complexity of user operation and can improve the user's convenience. In addition, since the portable terminal 80 and the aerial photography route generation system 10 can eliminate test photography, the unmanned aerial vehicle 100 can be prevented from colliding with any object or crashing during test photography, and the safety of the unmanned aerial vehicle 100 when same flies can be improved.

Next, an example of generating the scheduled aerial photography route will be described.

The aerial photography route generation unit 814 can generate, based on the past aerial photography route acquired from the image server 90, the scheduled aerial photography position by means of various methods.

When one past aerial photography route FPA is acquired from the image server 90, the aerial photography route generation unit 814 may set the past aerial photography route to be a scheduled aerial photography route FPS. The scheduled aerial photography route FPS is an example of the first aerial photography route. The past aerial photography route FPA is an example of t Accordingly, since the portable terminal 80 can use the past aerial photography route FPA registered in the image DB 991 as is, the scheduled aerial photography route FPS can be easily generated. Further, the portable terminal 80 sets the past aerial photography route FPA having a past result to be the scheduled aerial photography route FPS, and thus, like the past aerial photography route, the scheduled aerial photography route FP can be expected to be an aerial photography route where an aerial image with a high evaluation is obtained. In addition, the aerial photography route generation system 10 can improve processing efficiency when handling the image DB 991 by collectively managing the past aerial image and additional information thereabout by means of the image DB 991. The second aerial photography route.

Accordingly, since the portable terminal 80 can use the past aerial photography route FPA registered in the image DB 991 as is, the scheduled aerial photography route FPS can be easily generated. Further, the portable terminal 80 sets the past aerial photography route FPA having a past result to be the scheduled aerial photography route FPS, and thus, like the past aerial photography route, the scheduled aerial photography route FP can be expected to be an aerial photography route where an aerial image with a high evaluation is obtained. In addition, the aerial photography route generation system 10 can improve processing efficiency when handling the image DB 991 by collectively managing the past aerial image and additional information thereabout by means of the image DB 991.

The aerial photography route generation unit 814 may set one past aerial photography route FPA included in multiple past aerial photography routes PFP to be the scheduled aerial photography route FPS.

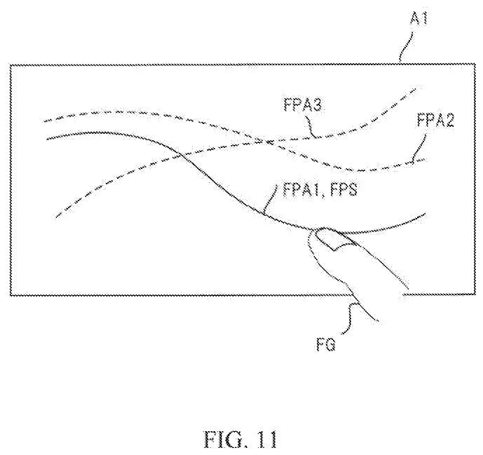

FIG. 11 is a diagram illustrating an example of selecting the scheduled aerial photography route FPS from multiple past aerial photography routes FPA. In FIG. 11, as a result of searching the image DB 991 based on the aerial photography range A1, three past aerial photography routes, FPA 1 to FPA 3, are acquired. The past aerial photography routes FPA1 to FPA 3 are displayed in the display unit 88. While the display unit 88 is confirmed, the user may select one past aerial photography route FPA1 from the past aerial photography routes FPA1 to FPA 3 via the operation unit 83. That is, the operation unit 83 may acquire selected information about the past aerial photography route FPA 1. The aerial photography route generation unit 814 generates a scheduled aerial photography route FPS by taking the acquired past aerial photography route FPA 1 as a scheduled aerial photography route FPS.

Accordingly, the portable terminal 80 can select, from among past aerial photography routes FPA with a high evaluation, the user's desired past aerial photography route FPA. Therefore, the portable terminal 80 can generate the scheduled aerial photography route FPS, which has a high possibility of photographing the user's desired aerial image.

The aerial photography route generation unit 814 may combine some or all of the multiple past aerial photography routes FPA and generate the scheduled aerial photography route FPS.

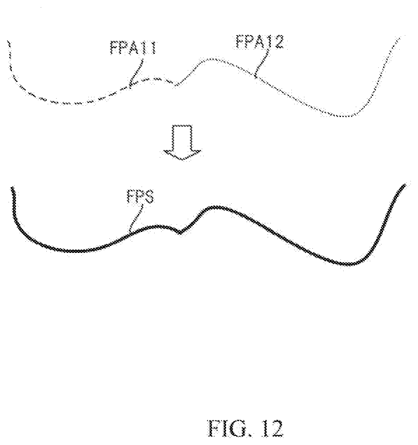

FIG. 12 is a diagram illustrating a first example of combining multiple past aerial photography routes FPA. In FIG. 12, as a result of searching the image DB 991 based on the aerial photography range A1, two past aerial photography routes, FPA 11 and FPA 12, are acquired. The aerial photography route generation unit 814 may generate a scheduled aerial photography route by combining the acquired two past aerial photography routes FPA11 and FPA12.

Accordingly, the portable terminal 80 can continuously fly along multiple past aerial photography routes FPA with a high evaluation and generate a scheduled aerial photography route FPS along which aerial photography can be carried out. Therefore, the unmanned aerial vehicle 100 can efficiently aerially photograph an attractive subject by flying along the scheduled aerial photography route FPS.

The aerial photography route generation unit 814 may acquire a crossing position CP where at least two past aerial photography routes FPA from among the multiple past aerial photography routes FPA cross each other. The aerial photography route generation unit 814 may separate each of the multiple past aerial photography routes FPA into two or more partial aerial photography routes, with the crossing position CP acting as a separation point. Incidentally, a plurality of crossing positions CP may be present in one past aerial photography route FPA. In this case, the past aerial photography route FPA is separated into three or more partial aerial photography routes. The aerial photography route generation unit 814 may generate a scheduled aerial photography route FPS that moves from an end portion of the past aerial photography route FPA, moves to another past aerial photography route FPA from the crossing position CP, and moves to an end portion of the other past aerial photography route FPA. That is, the aerial photography route generation unit 814 may connect the multiple partial aerial photography routes, with the crossing position CP acting as a connection point, and may generate a scheduled aerial photography route FPS.

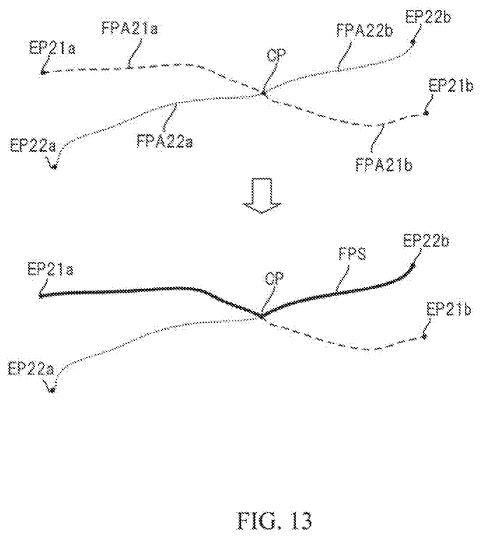

FIG. 13 is a diagram illustrating a second example of combining multiple past aerial photography routes FPA. In FIG. 13, as a result of searching the image DB 991 based on the aerial photography range A1, two past aerial photography routes, FPA 21 and FPA 22, are acquired. The past aerial photography route FPA 21 is an example of the third aerial photography route. The past aerial photography route FPA 22 is an example of the fourth aerial photography route. The past aerial photography routes FPA 21 and FPA 22 cross each other at a crossing position CP. The past aerial photography route FPA 21 includes partial aerial photography routes FPA 21a and FPA 21b. The partial aerial photography route FPA 21a connects an end portion EP 21a and the crossing position CP. The partial aerial photography route FPA 21a connects the end portion EP 21a and the crossing position CP. The past aerial photography route FPA 22 includes partial aerial photography routes FPA 22a and FPA 22b. The partial aerial photography route FPA 22a connects an end portion EP 22a and the crossing position CP. The partial aerial photography route FPA 22b connects an end portion EP 22b and the crossing position CP. The aerial photography route generation unit 814 may generate a scheduled aerial photography route FPS by connecting the partial aerial photography route FPA 21a of the past aerial photography route FPA 21 and the partial aerial photography route FPA 22b of the past aerial photography route FPA 22.

Accordingly, the portable terminal 80 can continuously fly along the partial aerial photography routes included in a past aerial photography route FPA with a high evaluation and generate a scheduled aerial photography route FPS along which aerial photography can be carried out. Therefore, the unmanned aerial vehicle 100 can efficiently aerially photograph an attractive subject with a high evaluation from another user by flying along the scheduled aerial photography route FPS.

The aerial photography route generation unit 814 may connect the partial aerial photography routes selected via the operation unit 83 when the partial aerial photography routes in different past aerial photography routes FPA are connected.

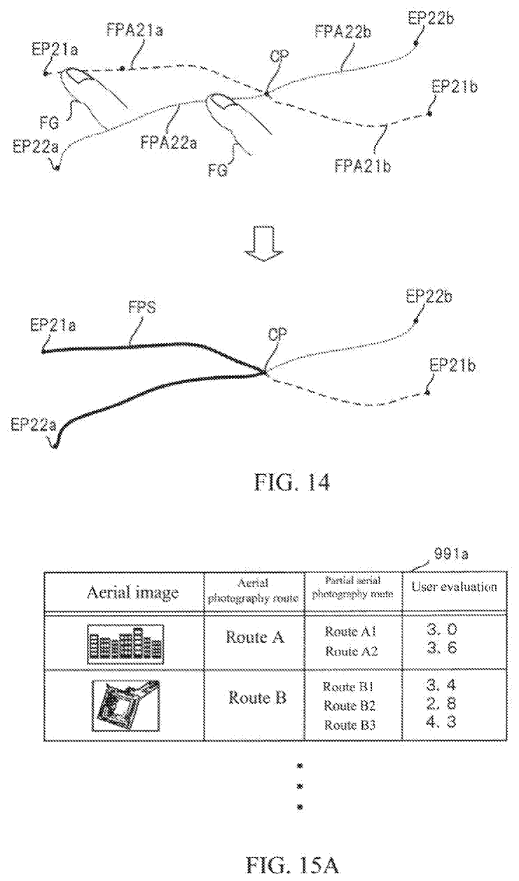

FIG. 14 is a diagram illustrating a third example of combining multiple past aerial photography routes FPA. In FIG. 14, the partial aerial photography routes FPA 21a and FPA 22a are selected by an input, to the operation unit 83, using a finger FG. The aerial photography route generation unit 814 may connect the partial aerial photography routes FPA 21a and FPA 22a, and thus generate a scheduled aerial photography route FPS.

Accordingly, the portable terminal 80 can continuously fly along the partial aerial photography routes which are selected to reflect an intention of the user and generate a scheduled aerial photography route FPS along which aerial photography can be carried out. Therefore, the unmanned aerial vehicle 100 can aerially photograph an attractive subject efficiently, which has a high evaluation from other users and which the user wishes to aerially photograph, by flying along the scheduled aerial photography route FPS.

When the partial aerial photography routes in different past aerial photography routes FPA are connected, the aerial photography route generation unit 814 may connect the partial aerial photography routes, the user evaluation of which, based on the user evaluation information about the aerial image which is aerially photographed on the partial aerial photography routes, is high.

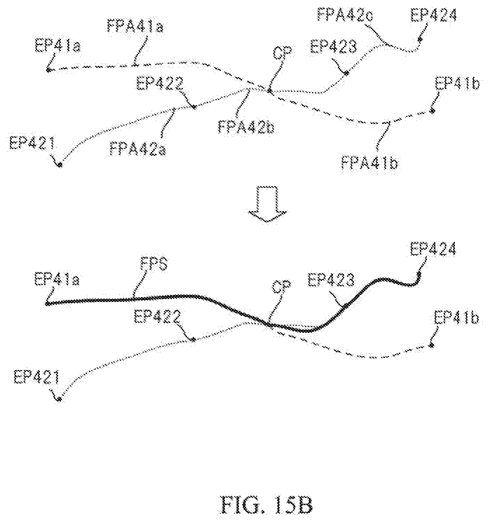

FIG. 15A is a diagram illustrating an example of an image DB 991a having a user evaluation regarding some of the aerial photography routes. Compared with the image DB 991, information about a partial aerial photography route and user evaluation information about the aerial photograph photographed on the partial aerial photography route are stored in the image DB 991a. Other information is the same as in the image DBs 991 and 991a, but some of the stored information is omitted in the image DB 991a.

FIG. 15B is a diagram illustrating a fourth example of combining multiple past aerial photography routes FPA. In FIG. 15B, as a result of searching the image DB 991 based on the aerial photography range A1, two past aerial photography routes, FPA 41 and FPA 42, are acquired. The past aerial photography routes FPA41 and FPA 42 cross each other at a crossing position CP. The past aerial photography route FPA41 includes partial aerial photography routes FPA 41a and FPA 41b. The partial aerial photography route FPA41a connects an end portion EP 41a and the crossing position CP. The partial aerial photography route FPA41b connects an end portion EP 41b and the crossing position CP. The past aerial photography route FPA42 includes partial aerial photography routes FPA 42a, FPA 42b, and FPA 42c. The partial aerial photography route FPA42a connects an end portion EP 421 and a point EP 422. The partial aerial photography route FPA42b connects the point EP 422 and a point 423. The partial aerial photography route FPA42c connects an end portion EP 423 and an end portion 424.

The partial aerial photography route FPA41a in FIG. 15B is equivalent to the route A1 in FIG. 15A. The partial aerial photography route FPA42c in FIG. 15B is equivalent to the route B3 in FIG. 15A. The aerial photography route generation unit 814 may refer to the image DB 991a, connect the partial aerial photography routes FPA 41a and FPA 42c, the evaluation thereof being high (for example, the evaluation value indicated by the user evaluation information is not less than the value 3.5), and generate a scheduled aerial photography route FPS. In addition, in FIG. 15B, although the crossing position CP, which is an end point of the partial aerial photography route FPA 41a, and the point 423, which is an end point of the partial aerial photography route FPA 41c, are separated, the aerial photography route generation unit 814 may carry out correction so as to connect the two points. That is, even when end points of multiple partial aerial photography routes do not coincide, the multiple aerial photography routes may be combined to generate a scheduled aerial photography route FPS.

Accordingly, the portable terminal 80 can continuously fly along the partial aerial photography routes with a high evaluation with respect to the partial aerial photography routes, and generate a scheduled aerial photography route FPS along which aerial photography can be carried out. Therefore, the unmanned aerial vehicle 100 can fly along the multiple partial aerial photography routes where an aerial image having a record that has been evaluated by another user is photographed, and can efficiently aerially photograph an attractive subject by flying along the scheduled aerial photography route FPS.

Next, an example of the generation of scheduled photography information will be described.

In the image server 90, additional information about an aerial image with a high evaluation is extracted, by using the aerial photography range as a key and from the additional information about the aerial image photographed on the aerial photography route included in the aerial photography range. Since the evaluation of the aerial image related to the additional information is high, it can be said that the extracted additional information is a subject which is attractive to other users who photograph the aerial image. In this case, it can be said that the photography information, such as the aerial photography angle of view and the aerial photography direction, in addition to the aerial photography position and the aerial photography route, is suitable for the aerial photography of the subject. Therefore, the photography information generation unit 817 may generate, based on the past photography information aerially photographed at the past aerial photography position or on the past aerial photography route extracted from the image DB 991, the scheduled photography information.

For example, the photography information generation unit 817 may use the past photography information acquired by the server information acquisition unit 813 as it is and as the scheduled photography information. For example, the photography information generation unit 817 may generate the scheduled photography information by processing at least part of the information about the past photography information acquired by the server information acquisition unit 813. For example, as in the generation of the aerial photography route, since a plurality of pieces of past photography information exist for the same past aerial photography route, the photography information generation unit 817 may use one piece of past photography information from the acquired plurality of pieces of past photography information as the scheduled photography information when the plurality of pieces of past photography information are acquired from the image DB 991. In this case, user selection may be carried out via the operation unit 83. In addition, the photography information generation unit 817 may average one piece of past photography information from the acquired plurality of pieces past photography information to be the scheduled photography information.

When the unmanned aerial vehicle 100 merely carries out aerial photography on the aerial photography route, it is considered that the unmanned aerial vehicle 100 is not facing an attractive subject and is not included in the photography range or that the setting of the angle of view is insufficient. In response to this, the portable terminal 80 can determine not only the aerial photography route (flight route) of the unmanned aerial vehicle 100, but also the desired photographing method (photography information) of the photographing device 220 or the photographing device 230. Therefore, the setting of photography information for photographing an attractive subject, that is, the setting of a camera, can be carried out, and the possibility of photographing a subject with high accuracy is further enhanced. In addition, since the scheduled photography information is generated by using the past photography information accumulated in the image DB 991, the portable terminal 80 can automatically carry out the setting of a camera, eliminating the user's need to manually set the camera, and improving the user's convenience.

Incidentally, an information processing device (e.g., the transmitter 50, the unmanned aerial vehicle 100, a PC, and other information processing devices) other than portable terminal 80 may have an aerial photography route generation function which the portable terminal 80 has.

### Second Embodiment

In the first embodiment, the generation, based on the additional information recorded in the image DB 991, of the scheduled aerial photography route without considering the aerial photography position is exemplified. In the second embodiment, it is assumed that a scheduled aerial photography route is generated based on the additional information recorded in the image DB 991 while taking an aerial photography position into consideration. Incidentally, in the second embodiment, a description of the configuration and operation similar to those of the first embodiment will be omitted or simplified.

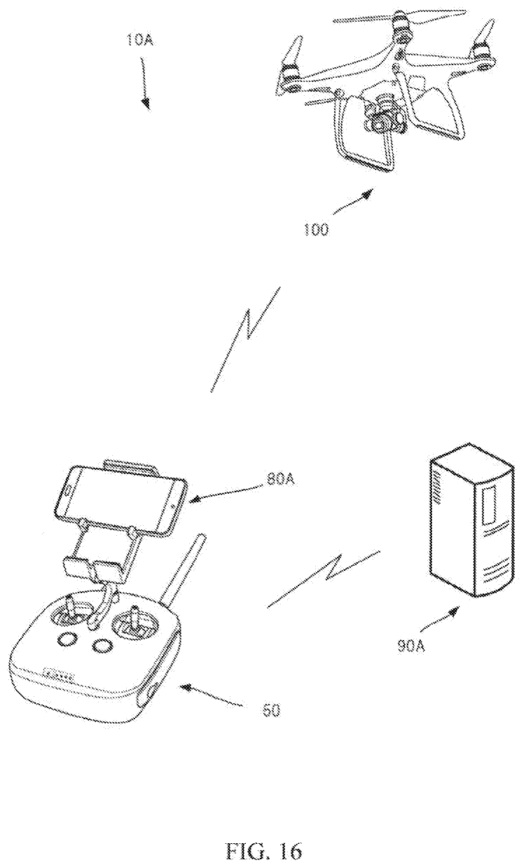

FIG. 16 is a pattern diagram illustrating an example of the configuration of an aerial photography route generation system 10A according to the second embodiment. The aerial photography route generation system 10A includes one or more unmanned aerial vehicles 100, a transmitter 50, a portable terminal 80A, and an image server 90A. The unmanned aerial vehicle 100, the transmitter 50, the portable terminal 80A, and the image server 90A can communicate with each other via wired communication or wireless communication (for example, wireless LAN).

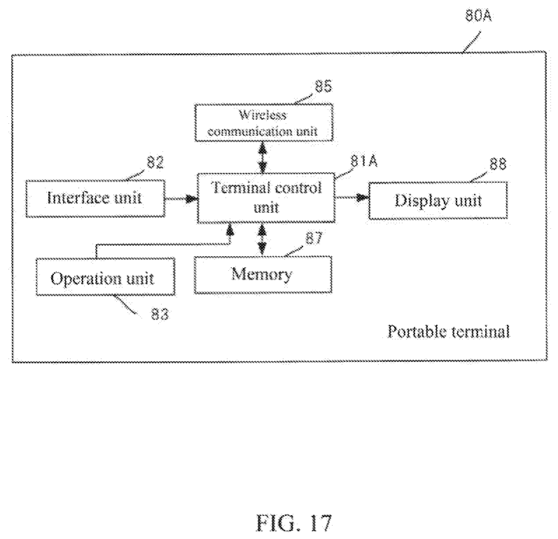

FIG. 17 is a block diagram illustrating an example of the hardware configuration of the portable terminal 80A. Compared with the portable terminal 80 in the first embodiment, the portable terminal 80A includes a terminal control unit 81A instead of the terminal control unit 81.

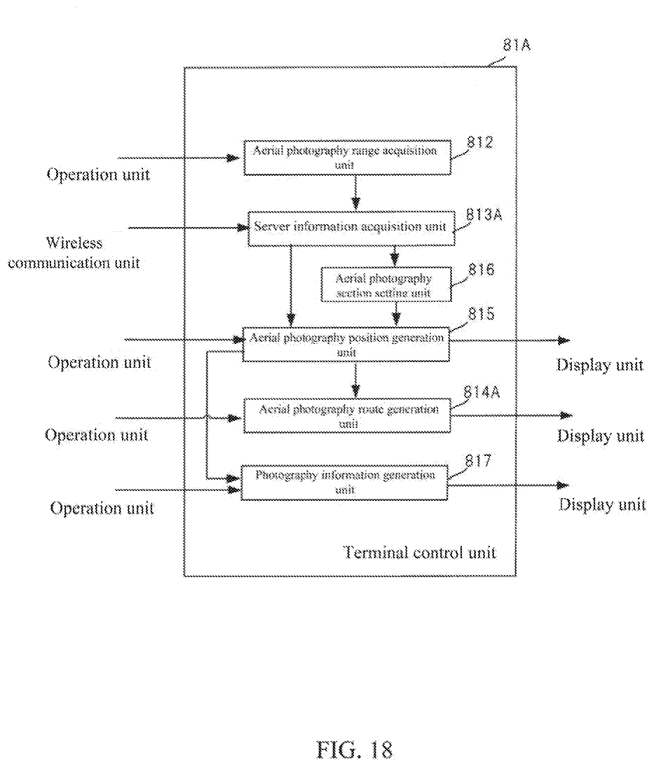

FIG. 18 is a block diagram illustrating an example of the functional configuration of the terminal control unit 81A. The terminal control unit 810A includes an aerial photography range acquisition unit 812, a server information acquisition unit 813A, an aerial photography route generation unit 814A, an aerial photography position generation unit 815, an aerial photography section setting unit 816, and a photography information generation unit 817. The server information acquisition unit 813A is an example of an acquisition unit. The aerial photography position generation unit 815 is an example of a generation unit. In the terminal control unit 81A shown in FIG. 18, the same reference numerals are given to configurations which are the same as those in the terminal control unit 81 shown in FIG. 4, and the description thereof will be omitted or simplified.

The server information acquisition unit 813A acquires data and information from the image server 90A via a wireless communication unit 85, for example. The data and information acquired from the image server 90A is at least some of the additional information based on the information, transmitted by the portable terminal 80A, about the aerial photography range. The server information acquisition unit 813A may acquire information, recorded in the image DB 991, about aerial photography positions (past aerial photography positions) and information about the past aerial photography route.

The aerial photography position generation unit 815 generates the aerial photography positions included in the aerial photography range. The aerial photography position generation unit 815 may generate, based on one or more of the acquired past aerial photography positions, one or more aerial photography positions (also referred to as scheduled aerial photography positions) for future aerial photography by the unmanned aerial vehicle 100. The aerial photography position generation unit 815 may generate, based on one or more acquired past aerial photography routes, one or more scheduled aerial photography positions.

The aerial photography route generation unit 814A generates an aerial photography route included in the aerial photography range. The aerial photography route generation unit 814A may generate one aerial photography route (a scheduled aerial photography route) which passes through one or more aerial photography positions generated by the aerial photography position generation unit 815.

The aerial photography section setting unit 816 divides an aerial photography range A1 into arbitrary sizes and sets the divided aerial photography ranges to be a plurality of aerial photography sections. The method for dividing the aerial photography sections may be retained in advance in a memory 87, or, the aerial photography section setting unit 816 may divide each aerial photography section into sections of equal area and retain the division result in the memory 87. The plurality of aerial photography sections may be set by retaining the information about the aerial photography sections in the memory 87.

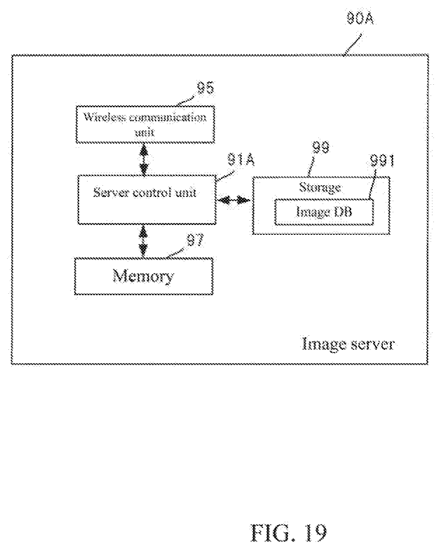

FIG. 19 is a block diagram illustrating an example of the hardware configuration of the image server 90A. Compared with the image server 90 in the first embodiment, the image server 90A includes a server control unit 91A instead of the server control unit 91.

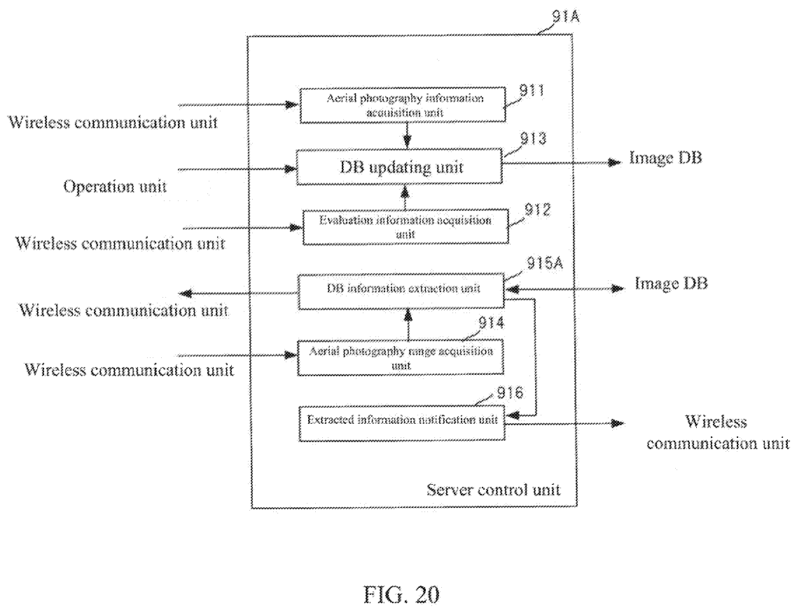

FIG. 20 is a block diagram illustrating an example of the functional configuration of the server control unit 91A. The server control unit 91A includes an aerial photography information acquisition unit 911, an evaluation information acquisition unit 912, a DB updating unit 913, an aerial photography range acquisition unit 914, a DB information extraction unit 915A, and an extracted information notification unit 916. In the server control unit 91A shown in FIG. 20, the same reference numerals are given to the configurations which are the same as those in the server control unit 91 shown in FIG. 6, and the description thereof will be omitted or simplified.

The DB information extraction unit 915A searches the image DB 991 based on the acquired aerial photography range, and extracts data and information from the image DB 991. For example, the DB information extraction unit 915A may extract, by using the aerial photography range as a key, one or more pieces of additional information about an aerial image (a still aerial image) which is aerially photographed at the aerial photography positions included in the aerial photography range. The DB information extraction unit 915A may extract, by using the aerial photography range as a key, one or more pieces of additional information about an aerial image (an aerial video) which is aerially photographed on the aerial photography route included in the aerial photography range. The DB information extraction unit 915A may extract, by using the aerial photography range as a key and from the additional information about the aerial image photographed at the aerial photography positions or on the aerial photography route included in the aerial photography range, additional information about an aerial image with a high evaluation from the additional information about the aerial image photographed at the aerial photography positions or on the aerial photography route included in the aerial photography range. The additional information to be extracted may include at least some of the information about the aerial photography positions and the aerial photography route where the aerial image, to which the additional information is added, is aerially photographed.

Next, an example of the operation of the aerial photography route generation system 10A will be described.

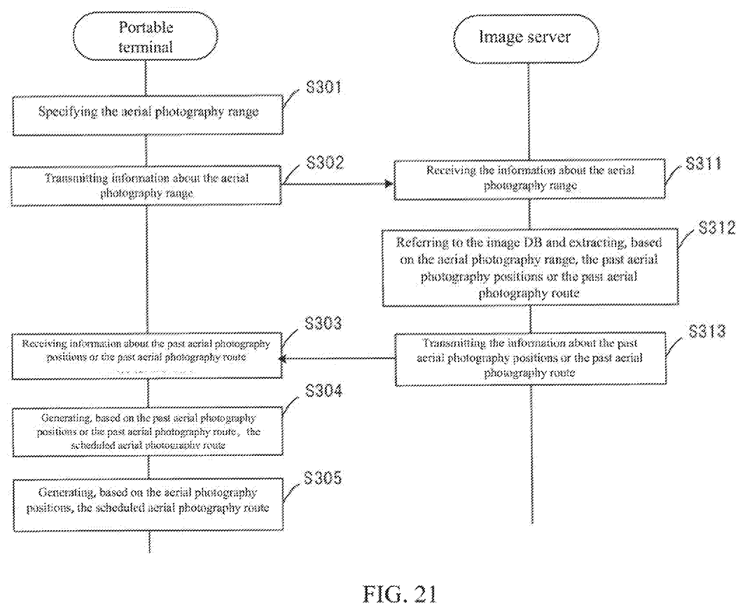

FIG. 21 is a flowchart illustrating an example of the operation when the scheduled aerial photography route is generated by the aerial photography route generation system 10A. Here, it is assumed that there is already one aerial image and additional information thereabout in the image DB 991.

First, in the portable terminal 80A, the aerial photography range acquisition unit 812 acquires the information about the aerial photography range A1 (S301). The wireless communication unit 85 transmits the information about the acquired aerial photography range A1 to the image server 90A (S302).

In the image server 90A, the aerial photography range acquisition unit 914 receives the information about the aerial photography range A1 (S311). The DB information extraction unit 915A refers to the image DB 991 and extracts, based on the aerial photography range A1, the past aerial photography positions or the past aerial photography route (S312). For example, the DB information extraction unit 915A may extract, by using the aerial photography range A1 as a key, one or more pieces of information about the past aerial photography positions or the past aerial photography route in the aerial photography range A1 and where an aerial image, the evaluation value of which is equal to or larger than a predetermined value (for example, a user evaluation value is equal to or greater than the value of 3.5, or is equal to or higher than an evaluation B), is aerially photographed. The extracted information notification unit 916 transmits the information about the past aerial photography positions or the past aerial photography route to the portable terminal 80A via the wireless communication unit 95 (S313).

In the portable terminal 80A, the server information acquisition unit 813 acquires, from the image server 90A, information about the past aerial photography positions or the past aerial photography route via the wireless communication unit 85 (S303). The aerial photography position generation unit 815 generates, based on the acquired past aerial photography positions or the past aerial photography route, scheduled aerial photography positions (S304). The aerial photography route generation unit 814A generates a scheduled aerial photography route that passes through the generated scheduled aerial photography positions (S305). Information about the generated scheduled aerial photography route is sent to the unmanned aerial vehicle 100 and is set to be an aerial photography route for the unmanned aerial vehicle 100.

Accordingly, the portable terminal 80A cooperates with the image server 90A to acquire the past aerial photography position or the past aerial photography route which is aerially photographed in a region to be aerially photographed (the aerial photography range A1). The second unmanned aerial vehicle 100 generates the scheduled aerial photography position from the past aerial photography position or the past aerial photography route. When the second unmanned aerial vehicle 100 flies through the scheduled aerial photography position and carries out aerial photography, the aerial image and the additional information thereabout are registered in the image DB 991. In this case, when the second unmanned aerial vehicle 100 photographs the still aerial image, the aerial image and information about the aerial photography position are registered in the image DB 991. Therefore, each time the unmanned aerial vehicle 100 carries out aerial photography based on the image DB 991, the aerial image and the additional information thereabout are registered. For example, when an aerial photography position with a high evaluation is selected, it is expected that the user who is planning to take an aerial photograph is also highly satisfied, because same is an aerial photography position where an aerial photography image which satisfied other users was aerially photographed. Also, it is expected that the flying frequency also becomes high and the user evaluation also becomes higher at the aerial photography position related to the aerial image with a high evaluation. Therefore, the image server 90A can provide information capable of generating a recommended aerial photography position recorded in the image DB 991 in an opportunity learning manner.

Therefore, according to the portable terminal 80A and the aerial photography route generation system 10A, a scheduled aerial photography position can be generated based on the information recorded in the image DB 991. Therefore, in order to photograph an attractive subject, it is not necessary for the user to manually carry out test photography and search for a desired aerial photography position. Therefore, the portable terminal 80A and the aerial photography route generation system 10A can reduce the complexity of user operation and can increase the user's convenience. In addition, since the portable terminal 80A and the aerial photography route generation system 10A can eliminate test photography, the unmanned aerial vehicle 100 can be prevented from colliding with any object or crashing during time of test photography, and the safety of the unmanned aerial vehicle 100 when same flies can be improved.

Next, an example of the generation of the scheduled aerial photography position and the scheduled aerial photography route will be described.

The aerial photography position generation unit 815 can generate, based on the past aerial photography position or the past aerial photography route acquired from the image server 90A, the scheduled aerial photography position by means of various methods.

When one or more past aerial photography positions FPB are acquired from the image server 90A, the aerial photography position generation unit 815 may set the past aerial photography position FPB to be a scheduled aerial photography position FPT. The aerial photography route generation unit 814A may generate one scheduled aerial photography route FPS passing through one or more scheduled aerial photography positions FPT. The scheduled aerial photography position FPT is an example of a first aerial photography position. The past aerial photography position FPB is an example of a second aerial photography position.

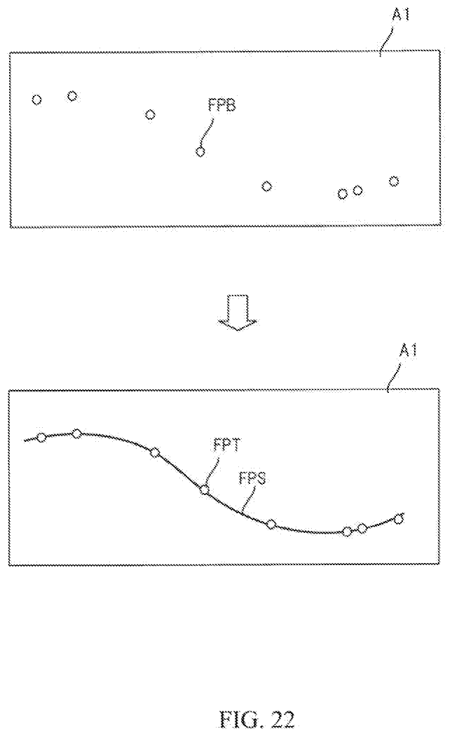

FIG. 22 is a pattern diagram illustrating a first example of the generation of a scheduled aerial photography position. In FIG. 22, as a result of searching the image DB 991 based on the aerial photography range A1, a plurality (here, eight) of past aerial photography positions FPB are acquired. The aerial photography position generation unit 815 sets the plurality of past aerial photography positions FPB to be a plurality of scheduled aerial photography positions FPT as they are. The aerial photography route generation unit 814A generates a scheduled aerial photography route FPS passing through the plurality of scheduled aerial photography positions FPT.

Accordingly, since the portable terminal 80A can use the past aerial photography positions FPB registered in the image DB 991 as they are, the scheduled aerial photography positions FPT can be easily generated. In addition, the portable terminal 80A sets the past aerial photography positions FPB having a past result to be the scheduled aerial photography positions FPT, and thus, like the past aerial photography positions FPB, the scheduled aerial photography positions FPT can be expected to be aerial photography positions where an aerial image with a high evaluation is obtained.

When multiple past aerial photography routes FPA are acquired from the image server 90A, the aerial photography position generation unit 815 may acquire one or more crossing positions CP from the multiple past aerial photography routes FPA by means of calculation or the like. The aerial photography position generation unit 815 may set the crossing positions CP to be the scheduled aerial photography positions FPT. The aerial photography route generation unit 814A may generate one scheduled aerial photography route FPS which passes through one or more scheduled aerial photography positions FPT.

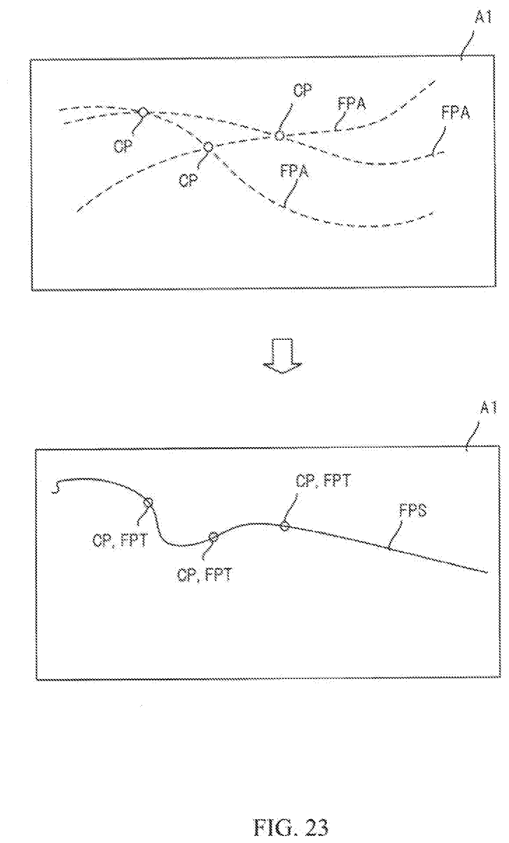

FIG. 23 is a pattern diagram illustrating a second example of the generation of a scheduled aerial photography position. In FIG. 23, as a result of searching the image DB 991 based on the aerial photography range A1, multiple (here, three) past aerial photography routes FPA are acquired. The aerial photography position generation unit 815 sets the crossing positions CP (here, three), where at least two of the multiple past aerial photography routes FPA cross each other, to be the scheduled aerial photography positions FPT. The aerial photography route generation unit 814A generates a scheduled aerial photography route FPS which passes through the plurality of scheduled aerial photography positions FPT.

Accordingly, since the portable terminal 80A sets the crossing positions CP of the multiple past aerial photography routes FPA registered in the image DB 991 to be the scheduled aerial photography positions FPT, the scheduled aerial photography positions FPT can be easily generated. Since any one of the multiple past aerial photography routes FPA is an aerial photography route with a high evaluation, it is predicted that the crossing positions CP of these aerial photography routes are positions with a very high evaluation. Therefore, it can be expected that an aerial image with a higher evaluation can be acquired by carrying out aerial photography at the scheduled aerial photography positions FPT. In addition, even if the still aerial image and the additional information thereabout are not registered in the image DB 991, the portable terminal 80A can generate, based on a past aerial image, the scheduled aerial photography positions FPT. That is, the portable terminal 80A can recommend, based on a past aerial video, a three-dimensional position suitable for acquiring a still aerial image.

When the plurality (for example, many) of past aerial photography positions FPB are acquired from the image server 90A, the aerial photography position generation unit 815 may set some of the plurality of past aerial photography positions FPB to be the scheduled aerial photography positions FPT, and some of the plurality of past aerial photography positions FPB may be excluded from the scheduled aerial photography positions FPT. The aerial photography route generation unit 814A may generate one scheduled aerial photography route FPS passing through one or more scheduled aerial photography positions FPT which are not excluded.

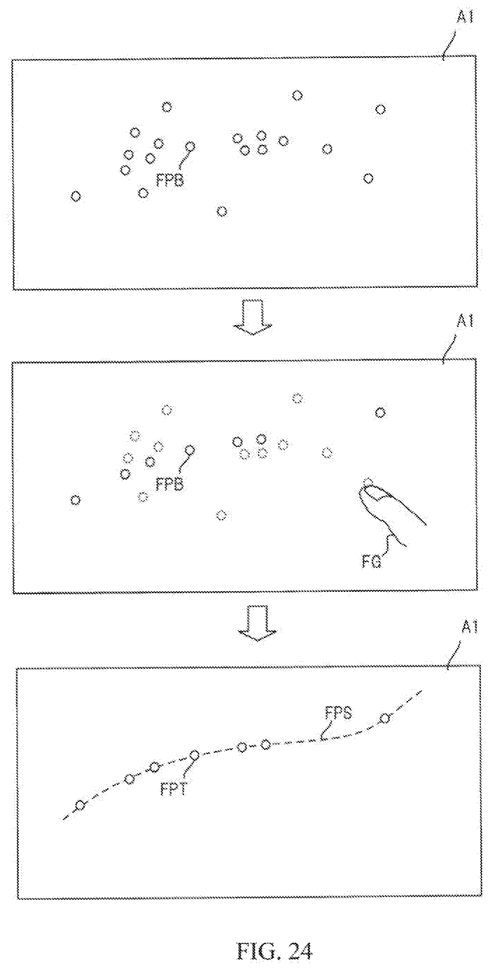

FIG. 24 is a pattern diagram illustrating a third example of the generation of a scheduled aerial photography position. In FIG. 24, as a result of searching the image DB 991 based on the aerial photography range A1, a plurality (here, 19) of past aerial photography positions FPB are acquired. The past aerial photography positions FPB are displayed on a display unit 88. While the display unit 88 is confirmed, the user may select one or more past aerial photography positions FPB from the past aerial photography positions FPB via the operation unit 83. In this case, the aerial photography position generation unit 815 may set the selected past aerial photography positions FPB to be the scheduled aerial photography positions FPT. In addition, while the display unit 88 is confirmed, the user may choose to exclude any one of the past aerial photography positions FPB from the past aerial photography positions FPB via the operation unit 83. In this case, the aerial photography position generation unit 815 may set the past aerial photography positions FPB which are not selected to be the scheduled aerial photography positions FPT. The aerial photography route generation unit 814A generates a scheduled aerial photography route FPS passing through the scheduled aerial photography positions FPT.

Accordingly, the portable terminal 80A can select the user's desired aerial photography position from past aerial photography positions FPB with a high evaluation. Therefore, the portable terminal 80A can generate scheduled aerial photography positions FPT with a high possibility of photographing the user's desired aerial image. In addition, even if there are many (for example, highly evaluated) past aerial photography positions FPB which are extracted from the image DB 991 and which correspond to conditions, the user can select representative aerial photography positions from among a large number of past aerial photography positions FPB. Therefore, the portable terminal 80A can prevent the number of aerial images photographed in the aerial photography range A1 from becoming too large and can realize a reduction in the capacity of the unmanned aerial vehicle 100 for recording an aerial image aerially photographed at each scheduled aerial photography position FPT, a reduction in the aerial photography time, an improvement in the aerial photography efficiency, or the like.

Next, the setting of the aerial photography sections will be described.

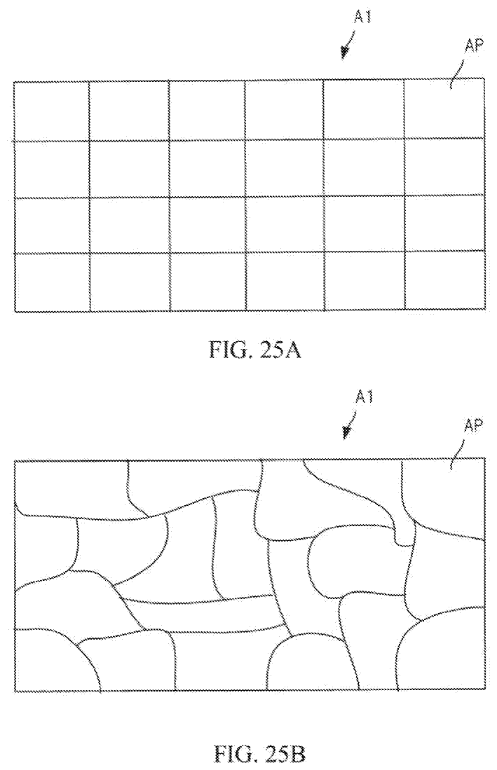

FIG. 25A is a pattern diagram illustrating an example of aerial photography sections AP. The aerial photography range A1 is divided into aerial photography sections AP of a lattice shape, as long as the respective areas of each of the aerial photography sections AP are the same. The aerial photography section setting unit 816 divides the aerial photography range A1 into a lattice shape to generate the aerial photography sections AP, and thus, the portable terminal 80A can easily set the aerial photography sections AP according to, for example, the latitude and longitude. In addition, when the portable terminal 80A generates the same number of scheduled aerial photography positions FPT in each of the aerial photography sections AP according to the aerial photography sections AP, the portable terminal 80A can evenly carry out aerial photography according to the geographical latitude and longitude.

FIG. 25B is a pattern diagram illustrating another example of the aerial photography sections AP. The aerial photography sections AP are divided by arbitrary line segments (curved lines or straight lines). The area of each aerial photography section AP may be the same. The aerial photography section setting unit 816 divides the aerial photography range A1 into arbitrary shapes to generate the aerial photography sections AP, and thus, the portable terminal 80A can easily set aerial photography sections AP of the user's desired shape. In addition, when the portable terminal 80A generates the same number of scheduled aerial photography positions FPT in each of the aerial photography sections AP according to each of the aerial photography sections AP, it is possible to aerially photograph subjects with the same probability in the same area.

Incidentally, the aerial photography section setting unit 816 may generate the aerial photography sections AP such that the respective areas of each of the aerial photography sections AP become unequal. For example, when a popular spot is biased toward a specific area within the aerial photography range A1, if there is a boundary between the land and the sea, and the range where aerial photography can be easily carried out from the land is limited, it is conceivable that there is a deviation in an aerial photography position with a high evaluation registered in the image DB 991. In this case, the aerial photography section setting unit 816 may set regions where it is expected that there are many past aerial photography positions with a high evaluation to be relatively small aerial photography sections AP and may set regions where it is expected that there are not many past aerial photography positions with a high evaluation to be relatively large aerial photography sections AP. In this case, when the portable terminal 80A generates the same number of scheduled aerial photography positions FPT in each of the aerial photography sections AP according to each of the aerial photography sections AP, it is possible to evenly aerially photograph subjects with a high evaluation.

Accordingly, the portable terminal 80A can generate the scheduled aerial photography positions FPT by taking the aerial photography sections AP in a range narrower than the aerial photography range A1 into account. Therefore, the possibility that the portable terminal 80A can more finely set the approximate scheduled aerial photography positions FPT can be increased.

FIG. 26 is a pattern diagram illustrating an example of the generation of the scheduled aerial photography positions FPT and the scheduled aerial photography route FPS based on the aerial photography sections AP. In FIG. 26, the aerial photography sections AP are set to be of a lattice shape.

In FIG. 26, there are a plurality of past aerial photography positions FPB. In addition, there are aerial photography sections AP having many past aerial photography positions FPB, and there are aerial photography sections AP having no past aerial photography position FPB. That is, there is a deviation in the positions of the past aerial photography positions FPB with a high evaluation. The portable terminal 80A may be adjusted such that the deviation of the arrangement of the scheduled aerial photography positions FPT generated based on the past aerial photography positions FPB is reduced. For example, the aerial photography position generation unit 815 may be set such that the number of scheduled aerial photography positions FPT generated in the aerial photography sections is not more than a predetermined number (for example, 1, 2, other numbers). Information about the upper limit number (for example, 1, 2, other numbers) of the scheduled aerial photography positions FPT in each of the aerial photography sections may be retained in the memory 87.

The past aerial photography positions FPB may be displayed on the display unit 88. While the display unit 88 is confirmed, the user may select a predetermined number (for example, two) of past aerial photography positions FPB from the past aerial photography positions FPB in each of the aerial photography sections AP via the operation unit 83. In this case, the aerial photography position generation unit 815 may set the selected past aerial photography positions FPB to be the scheduled aerial photography positions FPT. In addition, while the display unit 88 is confirmed, the user may choose to exclude past aerial photography positions FPB from among the past aerial photography positions FPB in each of the aerial photography sections AP via the operation unit 83. In this case, the aerial photography position generation unit 815 may set the past aerial photography positions FPB which are not selected to be the scheduled aerial photography positions FPT. The aerial photography route generation unit 814A generates a scheduled aerial photography route FPS passing through the scheduled aerial photography positions FPT.

Accordingly, the portable terminal 80A can select, from among the past aerial photography positions FPB with a high evaluation, the user's desired scheduled aerial photography positions FPT in each of the aerial photography sections AP. Therefore, the portable terminal 80A can suppress the occurrence of deviation in the scheduled aerial photography positions FPT and can determine scheduled aerial photography positions FPT with a high possibility of photographing the user's desired aerial image.

In addition, the aerial photography position generation unit 815 may set, in each of the aerial photography sections AP, a predetermined number (for example, two) of past aerial photography positions FPB from among a high evaluation to be the scheduled aerial photography positions FPT. The aerial photography route generation unit 814A generates a scheduled aerial photography route FPS passing through the scheduled aerial photography positions FPT.

Further, by means of setting the past aerial photography positions FPB having a past result in each of the aerial photography sections AP to be the scheduled aerial photography positions FPT, the portable terminal 80A can suppress the occurrence of deviation in the scheduled aerial photography positions FPT and can determine the scheduled aerial photography positions FPT at which an aerial image with a high evaluation can be obtained.

In addition, the aerial photography position generation unit 815 may set, in each of the aerial photography sections AP, past aerial photography positions FPB, the distance thereto from the centre point, the centre of gravity, and other reference points of the aerial photography section AP being short to be the scheduled aerial photography positions FPT. The aerial photography route generation unit 814A generates a scheduled aerial photography route FPS passing through the scheduled aerial photography positions FPT. As a result, for example, the portable terminal 80A can set the scheduled aerial photography route FPS at substantially equal intervals, and can support the uniform acquisition of aerial images along the scheduled aerial photography route FPS.

Next, the generation of a scheduled aerial photography route FPS based on the scheduled aerial photography positions FPT will be described.

Various methods regarding how to generate a scheduled aerial photography route FPS that passes through the scheduled aerial photography positions FPT generated by the aerial photography position generation unit 815 are conceivable. The method of generating the scheduled aerial photography route FPS may be determined by the operation mode of the portable terminal 80A, for example. The operation mode of the portable terminal 80A for generating the scheduled aerial photography route FPS may include a short distance mode, a smooth mode, an energy-saving mode, and other operation modes.

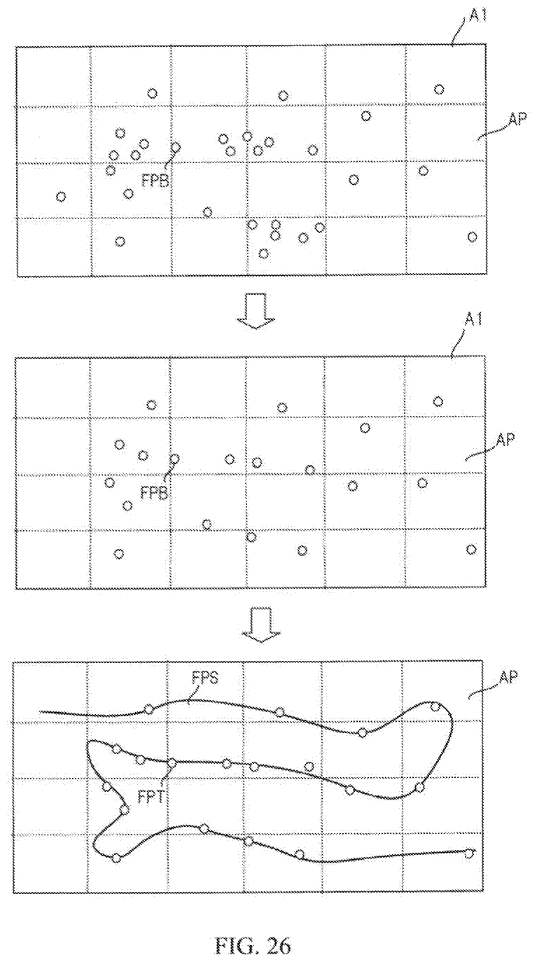

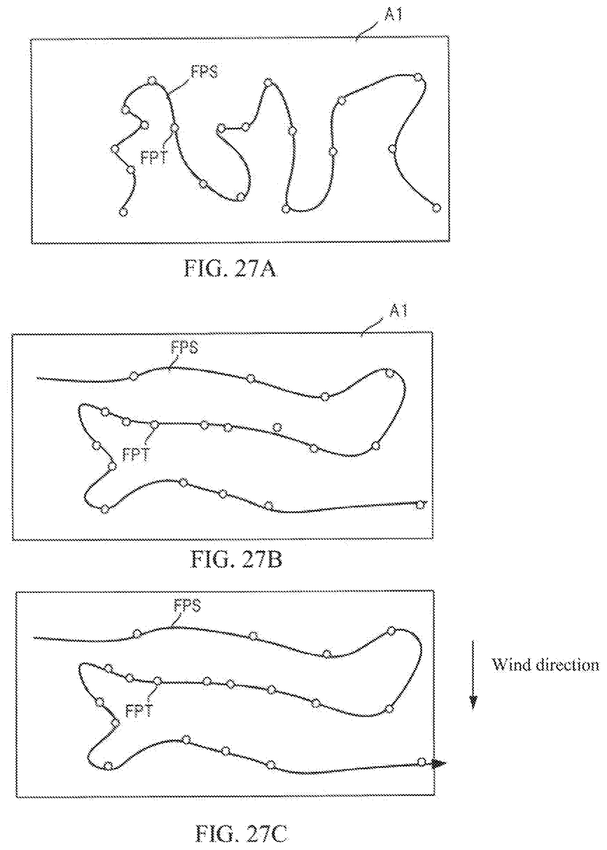

FIG. 27A is a pattern diagram illustrating an example of the generation of a scheduled aerial photography route FPS under a short distance mode. As shown in FIG. 27A, the aerial photography route generation unit 814A may generate, based on the distance (length) of the aerial photography route connecting the plurality of scheduled aerial photography positions FPT, the scheduled aerial photography route FPS. For example, the aerial photography route generation unit 814A may connect the plurality of scheduled aerial photography positions FPT by using the shortest distance and generate the scheduled aerial photography route FPS. The aerial photography route generation unit 814A may generate a scheduled aerial photography route FPS, in which the moving distance of the aerial photography route is equal to or shorter than a predetermined distance, even if this is not the shortest distance. In addition, the aerial photography route generation unit 814A may generate a plurality of candidates for the scheduled aerial photography route FPS by changing the order in which the plurality of scheduled aerial photography positions FPT are passed through. The aerial photography route generation unit 814A may calculate the moving distance of each of the candidates for the scheduled aerial photography route FPS. The aerial photography route generation unit 814A may generate any one of the aerial photography routes that is equal to or less than the average of the moving distances of the candidates, which are results of calculation, for the aerial photography route, so same is the scheduled aerial photography route FPS. The aerial photography route generation unit 814A may generate any one of the aerial photography routes which is a moving distance equal to or shorter than a predetermined multiple of the aerial photography route having the shortest distance, so same is the scheduled aerial photography route FPS.

Accordingly, the portable terminal 80A can reduce the total moving distance between the plurality of scheduled aerial photography positions FPT when the unmanned aerial vehicle 100A carries out aerial photography. Therefore, even if external factors serving as obstacles to the flight of the unmanned aerial vehicle 100A in the aerial photography range A1 (for example, in the case of flying among many building groups to carry out aerial photography) are widely present, the portable terminal 80A can reduce the possibility of colliding with other objects, and to stabilize and aerially photograph an attractive subject.

FIG. 27B is a pattern diagram illustrating an example of the generation of an aerial photography route FPS under a smooth distance mode. Each scheduled aerial photography position FPT in FIG. 27B is the same as each scheduled aerial photography position FPT in FIG. 27A. As shown in FIG. 27B, the aerial photography route generation unit 814A may generate a scheduled aerial photography route FPS based on the average curvature of the aerial photography route connecting the plurality of scheduled aerial photography positions FPT. For example, the aerial photography route generation unit 814A may smoothly connect the plurality of scheduled aerial photography positions FPT as much as possible and generate a scheduled aerial photography route FPS. In this case, the aerial photography route generation unit 814A may generate a plurality of candidates for the scheduled aerial photography route FPS by changing the order in which the plurality of scheduled aerial photography positions FPT are passed through. The aerial photography route generation unit 814A may calculate the average curvature at each point on the aerial photography route in each of the candidates for the scheduled aerial photography route FPS. Then, the aerial photography route generation unit 814A may generate a aerial photography route having the minimum average curvature, which is a result of calculation, same acting as the scheduled aerial photography route FPS. The aerial photography route having the minimum average curvature enables the unmanned aerial vehicle 100 to flight in the most linear manner. In addition, the aerial photography route generation unit 814A may generate any one of the aerial photography routes, the average curvature of which is equal to or less than the predetermined value, to be the scheduled aerial photography route FPS, even if the average curvature is not the minimum value.

Accordingly, the portable terminal 80A enables the unmanned aerial vehicle 100 to smoothly (linearly) move between the plurality of scheduled aerial photography positions FPT. Therefore, the portable terminal 80A makes it possible to move between the scheduled aerial photography positions FPT at a higher speed and enables aerial photography to be carried out in a short time. In addition, the portable terminal 80A makes it possible to move faster between the scheduled aerial photography positions FPT and to easily carry out aerial photography in a wide range.

FIG. 27C is a pattern diagram illustrating an example of the generation of an aerial photography route FPS under an energy-saving mode. Each scheduled aerial photography position FPT in FIG. 27C is the same as each scheduled aerial photography position FPT in FIGS. 27A and 27B. As shown in FIG. 27C, the aerial photography route generation unit 814A may generate, based on the aerial photography route connecting the plurality of scheduled aerial photography positions FPT and the information about the aerial photography environment of the aerial photography route (for example, the wind direction, and the wind speed), the scheduled aerial photography route FPS. For example, the aerial photography route generation unit 814A may connect the plurality of scheduled aerial photographing positions FPT so as not to go against the wind to the greatest possible extent to generate the scheduled aerial photography route FPS. In this case, the plurality of scheduled aerial photography positions FPT may be connected, and the scheduled aerial photography route FPS may be generated such that the angle formed by the travelling direction and the wind direction when travelling along the aerial photography route is, to the greatest possible extent, less than 90 degrees. In addition, the aerial photography route generation unit 814A may generate a plurality of candidates for the scheduled aerial photography route FPS by changing the order in which the plurality of scheduled aerial photography positions FPT are passed through. The aerial photography route generation unit 814A may calculate the average angle formed by the travelling direction and the wind direction in each of the candidates for the scheduled aerial photography route FPS. Then, the aerial photography route generation unit 814A may generate the aerial photography route, the average angle, which is a result of calculation, of which is the minimum value, to be the scheduled aerial photography route FPS. The aerial photography route, the average angle of which is the minimum value, enables the flight of the unmanned aerial vehicle 100 to save energy. In addition, the aerial photography route generation unit 814A may generate any one of the aerial photography routes, the average angle of which is equal to or less than the predetermined value, to be the scheduled aerial photography route FPS, even if the average angle is not the minimum value.

Accordingly, when the unmanned aerial vehicle 100 flies between the plurality of scheduled aerial photography positions FPT, the portable terminal 80A can provide a scheduled aerial photography route FPS that can use a lot of wind power and can thus reduce the energy required for the flight of the unmanned aerial vehicle 100. In addition, wind information, an example of information about the flight environment, and other information (for example, the temperature, and presence or absence of precipitation), etc., may be added to the energy-saving mode.

Next, an example of the evaluation of the aerial image recorded in the image DB 991 will be described.

The aerial image may be evaluated by user evaluation information. Accordingly, the portable terminal 80A can generate the scheduled aerial photography positions and the scheduled aerial photography route by taking the evaluation by other users into account. Since an aerial image with which another user is also satisfied is aerially photographed at the aerial photography positions or along the aerial photography route, it can be expected that the satisfaction level of the user planning to carry out aerial photography is also high.

The aerial image may be evaluated by an index other than the user evaluation information. The DB information extraction unit 915A may calculate, based on at least one piece of information included in the additional information about the aerial image, the evaluation value of the aerial image. For example, the DB information extraction unit 915A may calculate, based on a position evaluation value indicating the evaluation of the aerial photography positions, a time period evaluation value indicating the evaluation of the aerial photography time period, a time point evaluation value indicating the evaluation of the aerial photography time point, a user evaluation value, and the selectivity, the evaluation value of the aerial image.

The DB information extraction unit 915A may calculate an evaluation value E of the aerial image according to formula 1. Evaluation value E=position evaluation value×α+time period evaluation value×β+time point evaluation value×γ+user evaluation value×θ+selectivity×ρ(formula 1). Incidentally, α+β+γ+θ+ρ=1 is satisfied.

That is, at least some of the additional information about the aerial image recorded in the image DB 991 is weighted, and the evaluation value of the aerial image may be derived therefrom. Therefore, the values of the coefficients α, β, γ, θ, and ρ are determined such that the emphasized parameters are increased. For example, when it is desired to emphasize the time point evaluation value for photographing the sunset, the value of γ is set to be large.

In this case, the aerial photography information acquisition unit 911 may acquire, from the portable terminal 80A, the aerial photography position, the aerial photography time period, the aerial photography time point, and other information about when and where aerial photography is desired via the wireless communication unit 95. The other information may be information that matches at least one item included in the additional information added to the aerial image.

The position evaluation value may be determined based on the distance proximity between the aerial photography position included in the additional information recorded in the image DB 991 and the aerial photography position where aerial photography is desired. The closer the two aerial photography positions are, the higher the position evaluation value may be. The time period evaluation value may be determined based on the time proximity between the aerial photography time period included in the additional information recorded in the image DB 991 and the aerial photography time period when the aerial photography is desired. The closer the two aerial photography time periods are, the higher the time period evaluation value may be. The time point evaluation value may be determined based on the time proximity between the aerial photography time point included in the additional information recorded in the image DB 991 and the aerial photography time point when the aerial photography is desired. The closer the two aerial photography time points are, the higher the time period evaluation value may be. The user evaluation value may be an evaluation value indicating the above-described user evaluation information. The selectivity may be the selectivity of the above-described aerial photography positions or aerial photography route.

Therefore, an aerial image which is aerially photographed in the same situation (for example, the aerial photography positions, the aerial photography time period, the aerial photography time point) in the past with a high user evaluation is obtained, and the evaluation of the aerial photography positions and the aerial photography route which are selected frequently becomes high. Therefore, the portable terminal 80A can determine not only the user evaluation information but also the evaluation value of the past aerial image by using various indices presumed to be able to photograph an attractive object similarly to the past. Therefore, when the past aerial photography positions or the past aerial photography route obtained from the past aerial image with a high evaluation are extracted, various indices, such as the past flight conditions, the past aerial photography positions and the selection status of the past aerial photography route, are added. Therefore, the portable terminal 80A can generate scheduled aerial photography positions and a scheduled aerial photography route with a high possibility of photographing a desired subject in a comprehensive manner.

The aerial image may be evaluated by an index other than the user evaluation information and this is not limited to the present embodiment, and the same applies to the first embodiment. For example, this embodiment is not limited to using the evaluation value which uses (Formula 1) when the past aerial photography positions or the past aerial photography route in the present embodiment is extracted, and the evaluation value which uses (Formula 1) when the past aerial photography route in the first embodiment is extracted may be used.

Incidentally, an information processing device (e.g., the transmitter 50, the unmanned aerial vehicle 100, the PC, and other information processing devices) other than the portable terminal 80A may have an aerial photography route generation function which the portable terminal 80A has.

### Another Embodiment

In the first embodiment, the portable terminal 80 generates the scheduled aerial photography route FPS, but this embodiment is not limited thereto. For example, the image server 90 may generate the scheduled aerial photography route FPS. In this case, the image server 90 has the same aerial photography route generation function as the aerial photography route generation unit 814 of the portable terminal 80.

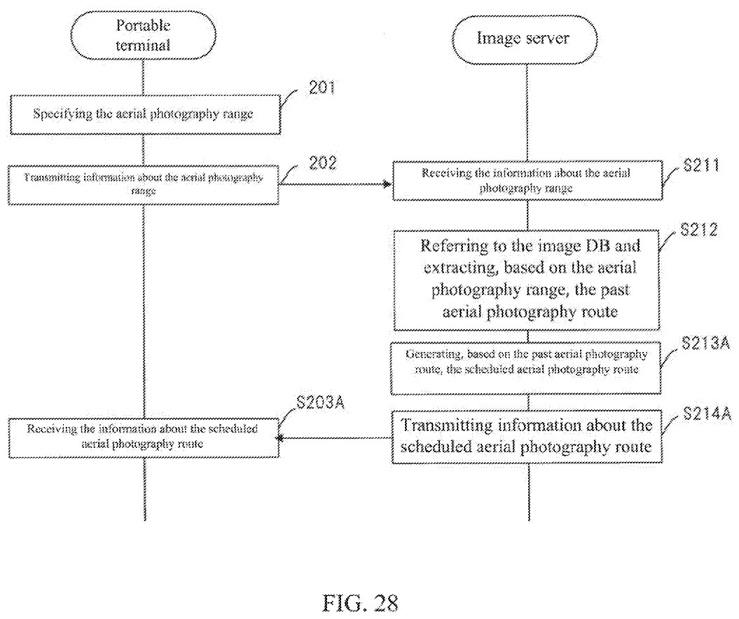

FIG. 28 is a sequence diagram showing a first example of the operation at the time of generating an aerial photography route according to the other embodiment. In FIG. 28, the processing which is the same as that in FIG. 10 is denoted by the same step numbers as those in FIG. 10, and the description thereof is omitted or simplified.

That is, in the image server 90, the DB information extraction unit 915 refers to the image DB 991 and extracts, based on the aerial photography range A1, the past aerial photography route FPA (S212). Further, the aerial photography route generation unit (not shown) generates the scheduled aerial photography route FPS based on the past aerial photography route FPA (S213A). The wireless communication unit 95 transmits information about the generated scheduled aerial photography route FPS to the portable terminal 80 (S214A). In the portable terminal 80, the wireless communication unit 85 receives the information about the scheduled aerial photography route FPS from the image server 90 (S203A). The received information about the scheduled aerial photography route FPS is sent to the unmanned aerial vehicle 100 and is set to be an aerial photography route for the unmanned aerial vehicle 100.

According to the operation in FIG. 28, the image server 90 and the aerial photography route generation system 10 can use resources of the image server 90 to reduce the processing load of the portable terminal 80 and generate the scheduled aerial photography route. In this case, it is also possible to improve the convenience of the user in generating the aerial photography route and to improve the safety of the unmanned aerial vehicle 100.

In the second embodiment, the portable terminal 80A generates the scheduled aerial photography positions FPT and the scheduled aerial photography route FPS, but this embodiment is not limited thereto. For example, the image server 90A may generate the scheduled aerial photography positions FPT and the scheduled aerial photography route FPS. In this case, the image server 90A has an aerial photography position generation unit and an aerial photography route generation function which are the same as the aerial photography position generation unit 815 and the aerial photography route generation unit 814A of the portable terminal 80. Further, the portable terminal 80A may generate the scheduled aerial photography positions FPT, and the image server 90A may generate the scheduled aerial photography route FPS.

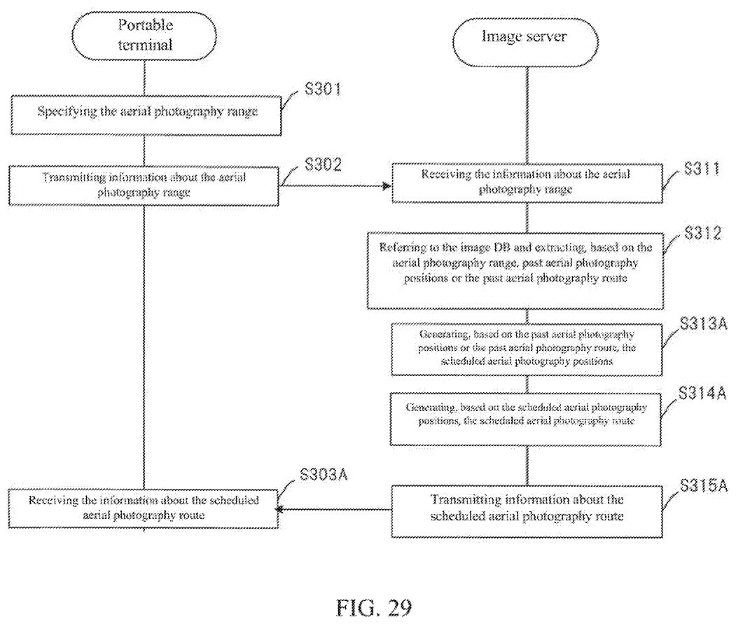

FIG. 29 is a sequence diagram showing a second example of the operation at the time of generating an aerial photography route according to the other embodiment. In FIG. 29, the processing which is the same as that in FIG. 21 is denoted by the same step numbers as those in FIG. 21, and the description thereof is omitted or simplified.

That is, in the image server 90A, the DB information extraction unit 915 refers to the image DB 991 and extracts, based on the aerial photography range A1, the past aerial photography positions FPB or the past aerial photography route FPA (S312). Further, the aerial photography position generation unit (not shown) generates, based on the past aerial photography positions FPB or the past aerial photography route FPA, the scheduled aerial photography positions FPT (S313A). Further, the aerial photography route generation unit (not shown) generates, based on the scheduled aerial photography positions FPT, the scheduled aerial photography route FPS (S314A). The wireless communication unit 95 transmits, to the portable terminal 80A, the information about the generated scheduled aerial photography route FPS (S315A). In the portable terminal 80A, the wireless communication unit 85 receives the information about the scheduled aerial photography route FPS from the image server 90A (S303A). The received information about the scheduled aerial photography route FPS is sent to the unmanned aerial vehicle 100 and is set to be an aerial photography route for the unmanned aerial vehicle 100.

According to the operation in FIG. 29, the image server 90A and the aerial photography route generation system 10A can use resources of the image server 90A to reduce the processing load of the portable terminal 80A and generate the scheduled aerial photography positions and the scheduled aerial photography route. In this case, it is also possible to improve the convenience of the user in generating the aerial photography positions and the aerial photography route and to improve the safety of the unmanned aerial vehicle 100.

Although the present disclosure has been described using the embodiments, the technical scope of the present disclosure is not limited to the scope described in the above-described embodiments. It is apparent to a person skilled in the art that various alterations or improvements are added to the above-described embodiments. It is also apparent from the description of the claims that embodiments with such alterations or improvements can be included in the technical scope of the present disclosure.

It should be noted that the order of carrying out each instance of processing, such as an operation, procedure, step, and stage in a device, system, program, and method shown in the claims, the specification, and the drawings may be implemented in any order unless otherwise indicated by “before” and “prior”, etc., and that the output of the previous instance of processing is not used in subsequent processing. For convenience, even if the operation flow in the claims, specification, and drawings is described using “first,” “next,” or the like, it does not mean that same is necessarily executed in this order.

### DESCRIPTION OF THE REFERENCE NUMERALS

10, 10A Aerial photography route generation system
50 Transmitter
80, 80A Portable terminal
81, 81A Terminal control unit
82 Interface unit
83 Operation unit
85 Wireless communication unit
87 Memory
88 Display unit
90 Image server
91 Server control unit
95 Wireless communication unit
97 Memory
99 Storage
100 Unmanned aerial vehicle
110 UAV control unit
150 Communication interface
160 Memory
200 Gimbal
210 Rotary wing mechanism
220, 230 Photographing device
240 GPS receiver
250 Inertial measurement unit
260 Magnetic compass
270 Pressure altimeter
812 Aerial photography range acquisition unit
813, 813A Server information acquisition unit
814, 814A Aerial photography route generation unit
815 Aerial photography position generation unit
816 Aerial photography section setting unit
911 Aerial photography information acquisition unit
912 Evaluation information acquisition unit
913 DB updating unit
914 Aerial photography range acquisition unit
915, 915A DB information extraction unit
916 Extracted information notification unit
991 Image DB

What is claimed is:

1. An information processing device comprising:
a memory storing a program; and
a processor configured to execute the program to:
obtain information about an aerial photography range for a first aerial image; and
generate an aerial photography route for aerially photographing the first aerial image based on evaluation information of one or more second aerial images aerially photographed in the aerial photography range.

2. The information processing device according to claim 1, wherein:
each of the one or more second aerial images includes an aerial video;
the aerial photography route is a first aerial photography route; and
the processor is further configured to execute the program to:
acquire, based on the evaluation information, information of one or more second aerial photography routes, each of the one or more second aerial images being photographed along one of the one or more second aerial photography routes; and
generate the first aerial photography route based on the one or more second aerial photography routes.

3. The information processing device according to claim 2, wherein the processor is further configured to execute the program to:
receive selection information for selecting one of the one or more second aerial photography routes; and
set at least a part of the selected one of the one or more second aerial photography routes as the first aerial photography route.

4. The information processing device according to claim 2, wherein:
the one or more second aerial photography routes include multiple second aerial photography routes; and
the processor is further configured to execute the program to:
receive information about the multiple second aerial photography routes; and
combine at least some of the multiple second aerial photography routes to generate the first aerial photography route.

5. The information processing device according to claim 4, wherein:
each of the multiple second aerial photography routes includes a plurality of parts; and
the processor is further configured to execute the program to:
acquire a plurality of parts of the multiple second aerial photography routes based on partial evaluation information of the second aerial image aerially photographed in the plurality of parts of a corresponding one of the multiple second aerial photography routes; and
combine some of the acquired parts of the multiple second aerial photography routes to generate the first aerial photography route.

6. The information processing device according to claim 2, further comprising:
a display configured to display information about the one or more second aerial photography routes.

7. The information processing device according to claim 1, wherein:
each of the one or more second aerial images includes a still aerial image or an aerial video;
the aerial photography route is a first aerial photography route passing through one or more first aerial photography positions for aerially photographing the first aerial image; and
the processor is further configured to execute the program to:
acquire, based on the evaluation information, information about one or more second aerial photography positions or one or more second aerial photography routes, each of the one or more second aerial images being photographed at one of the one or more second aerial photography positions or along one of the one or more second aerial photography routes;
generate the one or more first aerial photography positions based on the one or more second aerial photography positions or the one or more second aerial photography routes; and
generate the first aerial photography route based on the one or more first aerial photography positions.

8. The information processing device according to claim 7, wherein each of the one or more first aerial photography positions corresponds to one of one or more aerial photography sections obtained by dividing the aerial photography range.

9. The information processing device according to claim 8, wherein:
the one or more second aerial photography positions include multiple second aerial photography positions; and
the processor is further configured to execute the program to:
obtain selection information for selecting one or more of the multiple second aerial photography positions that are in the one or more aerial photography sections; and
set the selected one or more of the multiple second aerial photography positions as the one or more first aerial photography positions in the one or more aerial photography sections.

10. The information processing device according to claim 8, wherein the processor is further configured to execute the program to:
select at least one of the one or more second aerial images that has a high evaluation value based on the evaluation information; and
set at least one of the one or more second aerial photography positions corresponding to the at least one of the one or more second aerial images as the one or more first aerial photography positions in the one or more aerial photography sections.

11. The information processing device according to claim 7, wherein the processor is further configured to execute the program to:
generate multiple candidate routes for the first aerial photography route; and
determine the first aerial photography route based on respective distances between end portions of each of the multiple candidate routes.

12. The information processing device according to claim 7, wherein the processor is further configured to execute the program to:
generate multiple candidate routes for the first aerial photography route; and
determine the first aerial photography route based on information about an aerial photography environment of the multiple candidate routes.

13. The information processing device according to claim 1, wherein:
the aerial photography route is a first aerial photography route passing through one or more first aerial photography positions; and
the evaluation information is based on at least one of:
a difference between first flight information about a first flying object scheduled to aerially photograph the first aerial image and second flight information about a second flying object that photographed the one or more second aerial images,
evaluation information from a user who has confirmed the one or more second aerial images, or
acquisition information based on a number of times that one or more second aerial photography positions or one or more second aerial photography routes where the one or more second aerial images are aerially photographed are used for generating the first aerial photography route.

14. An aerial photography route generation method comprising:
obtaining information about an aerial photography range for a first aerial image; and
generating an aerial photography route for aerially photographing the first aerial image based on evaluation information of one or more second aerial images aerially photographed in the aerial photography range.

15. The aerial photography route generation method according to claim 14,
wherein each of the one or more second aerial images includes an aerial video and the aerial photography route is a first aerial photography route;
the method further comprising:
acquiring, based on the evaluation information, information of one or more second aerial photography routes, each of the one or more second aerial images being photographed along one of the one or more second aerial photography routes;
wherein generating the first aerial photography route includes generating the first aerial photography route based on the one or more second aerial photography routes.

16. The aerial photography route generation method according to claim 15, further comprising:
receiving selection information for selecting one of the one or more second aerial photography routes;
wherein generating the first aerial photography route includes setting at least a part of the selected one of the one or more second aerial photography routes as the first aerial photography route.

17. The aerial photography route generation method according to claim 15, wherein:
acquiring the information of the one or more second aerial photography routes includes receiving information about multiple second aerial photography routes; and
generating the first aerial photography route includes combining at least some of the multiple second aerial photography routes to generate the first aerial photography route.

18. The aerial photography route generation method according to claim 14, wherein generating the aerial photography route includes:
generating multiple candidate routes for the aerial photography route; and
determining the aerial photography route based on respective distances between end portions of each of the multiple candidate routes.

19. The aerial photography route generation method according to claim 14, wherein generating the aerial photography route includes:
generating multiple candidate routes for the aerial photography route; and
determining the aerial photography route based on information about an aerial photography environment of the multiple candidate routes.

20. A computer-readable storage medium storing a program that, when executed by a processor, causes the processor to:
obtain information about an aerial photography range for a first aerial image; and
generate an aerial photography route for aerially photographing the first aerial image based on evaluation information of one or more second aerial images aerially photographed in the aerial photography range.
